(19) United States
(12) Patent Application Publication
(10) Pub. No.: US 2020/0184587 A1
(43) Pub. Date: Jun. 11, 2020

(54) Method and System for Faculty Resource Management Using a Faculty Database Structure

(71) Applicants: Mark Schultze, League City, TX (US); Todd Leach, Dickinson, TX (US); Michelle Moreno, Galveston, TX (US); David L. Callender, Galveston, TX (US)

(72) Inventors: Mark Schultze, League City, TX (US); Todd Leach, Dickinson, TX (US); Michelle Moreno, Galveston, TX (US); David L. Callender, Galveston, TX (US)

(73) Assignee: Board of Regents, The University of Texas System, Austin, TX (US)

(21) Appl. No.: 16/705,046

(22) Filed: Dec. 5, 2019

Related U.S. Application Data
(60) Provisional application No. 62/776,972, filed on Dec. 7, 2018.

(51) Int. Cl. G06Q 50/20; G06F 21/62; G06Q 10/06

(52) U.S. Cl. CPC G06Q 50/205; G06Q 10/06398; G06Q 10/06393; G06F 21/6245

(57) ABSTRACT

A system and computerized method for managing faculty resources includes providing an input/output interface, a memory, and one or more processors communicably coupled to the input/output interface and the memory, providing a faculty database structure communicably coupled to the one or more processors and one or more databases, wherein the faculty database structure comprises a faculty profile for each faculty member that links personal data, position data, evaluation criteria and performance data together for the faculty member, selecting one or more of the faculty profiles using the input/output interface, determining a performance score for each selected faculty profile by comparing the performance data to the evaluation criteria using the one or more processors, and providing the performance score for each selected faculty profile to the input/output interface.

### CROSS-REFERENCE TO RELATED APPLICATIONS

This application claims priority to U.S. Provisional Application Ser. No. 62/776,972 filed Dec. 7, 2018 and entitled “Method And System For Faculty Resource Management Using A Faculty Database Structure”, the entire contents of which are incorporated herein by reference.

### TECHNICAL FIELD OF THE INVENTION

The present invention relates generally to the field of information systems and, more particularly, to a method and system for managing faculty resources using a faculty database structure.

### INCORPORATION-BY-REFERENCE OF MATERIALS FILED ON COMPACT DISC

None.

### STATEMENT OF FEDERALLY FUNDED RESEARCH

None.

### BACKGROUND OF THE INVENTION

Typical personnel management systems are based on business structures and personnel. These personal management systems do not address the unique characteristics and structure of faculty-based institutions (e.g., colleges, universities, research centers, etc.). For example, faculty job descriptions and metrics may include clinical duties, research duties, educational duties, administrative duties, monetary procurement (e.g., endowments, grants, sponsored research, etc.), recognition (e.g., awards, speaking engagements, publication, intellectual property, etc.), tenure and collaborative activities. Moreover, it is rare that two faculty members have same profile, duties, metrics and compensation.

As a result, there is a need for a method and system for faculty resource management that uses a faculty database structure.

### SUMMARY OF THE INVENTION

The disclosed invention relates to a comprehensive integrated faculty resource management method and system derived out of the University of Texas Medical Branch's need to access, utilize, link, host, and secure disparate data systems such as electronic medical records, financial records, and clinical records to support administrators to effectively and efficiently make decisions on all aspect of the maintenance of the faculty pool and candidates that may make up a faculty pool.

In one embodiment, a computerized method of enterprise faculty resource management and reporting (a) compares one or more of the faculty and/or candidate profiles to a preset plan, KPI, metric, benchmark, and/or effort using the computer system, (b) utilizes the comparative data for scoring a faculty and/or candidate against another faculty and/or candidate for the purposes for ranking, (c) determines the positioning of the faculty and/or candidate in relation to a preset plan, KPI, metric, benchmark, and/or effort using the computer system.

In another embodiment, a system for managing faculty resources includes an input/output interface, a memory, a faculty database structure, and one or more processors communicably coupled to the input/output interface, the memory and the faculty database structure. The comprises a faculty profile for each faculty member that links personal data, position data, evaluation criteria and performance data together for the faculty member. The one or more processors receive one or more of the faculty profiles selected via the input/output interface, determine a performance score for each selected faculty profile by comparing the performance data to the evaluation criteria, and provide the performance score for each selected faculty profile to the input/output interface.

In one aspect, the faculty member can be an existing, past or prospective faculty member. In another aspect, the evaluation criteria can be plans, key performance indicators (KPI), benchmarks, or efforts. In another aspect, the performance data can be clinical, administrative, compensation, grant management, teaching or productivity results. In another aspect, the one or more processors update the faculty profile with the performance score. In another aspect, the one or more processors compare the performance score of one faculty member to another performance score of one or more other faculty members. In another aspect, the one or more processors determine a management recommendation based on the performance score. In another aspect, the management recommendation comprises a hiring, terminating, promoting, disciplining, coaching or retaining recommendation. In another aspect, the one or more processors automatically send the management recommendation to a device of the selected faculty member. In another aspect, the one or more processors display the management recommendation on a visual enabled device comprising at least one of a computer, a smart phone, or tablet. In another aspect, the one or more processors automatically calculate a salary incentive for the faculty member. In another aspect, the one or more processors automatically calculate a teaching effort for the faculty member. In another aspect, the one or more processors automatically calculate compensation and an associated incentive for a new faculty member. In another aspect, the one or more processors associate two or more faculty profiles with a team. In another aspect, the faculty profiles and the one or more databases using a single security model. In another aspect, the personal data comprises at least one unique identifier comprising a faculty name, social security number, employee ID number, or faculty title. In another aspect, the faculty further comprises historical or legacy data for aggregate, time-point, or benchmark comparisons with the historical or legacy data of one or more faculty members. In another aspect, the one or more processors display at least one of a metric, a recommendation or a faculty profile comparison in a dashboard format on one or more devices.

In another embodiment, a computerized method for managing faculty resources comprises: providing an input/output interface, a memory, and one or more processors communicably coupled to the input/output interface and the memory; providing a faculty database structure communicably coupled to the one or more processors and one or more databases, wherein the faculty database structure includes a faculty profile for each faculty member that links personal data, position data, evaluation criteria, and performance data together for the faculty member; selecting one or more of the faculty profiles using the input/output interface; determining a performance score for each selected faculty profile by comparing the performance data to the evaluation criteria using the one or more processors; and providing the performance score for each selected faculty profile to the input/output interface.

In on aspect, the faculty member can be an existing, past or prospective faculty member. In another aspect, the evaluation criteria can be plans, key performance indicators (KPI), benchmarks, or efforts. In another aspect, the performance data can be clinical, administrative, compensation, grant management, teaching or productivity results. In one aspect, the method updates the faculty profile with the performance score. In another aspect, the method compares the performance score of one faculty member to another performance score of one or more other faculty members. In another aspect, the method determines a management recommendation based on the performance score. In another aspect, the management recommendation comprises a hiring, terminating, promoting, disciplining, coaching or retaining recommendation. In another aspect, the method automatically sends the management recommendation to a device of the selected faculty member. In another aspect, the method displays the management recommendation on a visual enabled device comprising at least one of a computer, a smart phone, or tablet. In another aspect, the method automatically calculates a salary incentive for the faculty member. In another aspect, the method automatically calculates a teaching effort for the faculty member. In another aspect, the method automatically calculates compensation and an associated incentive for a new faculty member. In another aspect, the method associates two or more faculty profiles with a team. In another aspect, the method protects the faculty profiles and the one or more databases using a single security model. In another aspect, the personal data comprises at least one unique identifier comprising a faculty name, social security number, employee ID number, or faculty title. In another aspect, the faculty further comprises historical or legacy data for aggregate, time-point, or benchmark comparisons with the historical or legacy data of one or more faculty members. In another aspect, the method displays at least one of a metric, a recommendation or a faculty profile comparison in a dashboard format on one or more devices.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 is a block diagram of a system according to an embodiment of the current invention;

FIG. 2 is a flow chart of a method in according to an embodiment of the current invention;

FIG. 3 is a hub and spoke diagram outlining the data components and related modules of the method and system according to an embodiment of the current invention;

FIG. 4 is a workflow diagram outlining the data point integrations according to an embodiment of the current invention;

FIG. 5 is a block diagram illustrating various modules of a faculty resource management system in accordance with an embodiment of the current invention;

FIGS. 6-13 are user interface examples for the Team Module according to an embodiment of the current invention;

FIGS. 14-16 are user interface examples for the Plan (Recruitment) Module according to an embodiment of the current invention;

FIGS. 17-20 are user interface examples for the Candidate Module according to an embodiment of the current invention;

FIG. 21 is a user interface example for the MOA Module according to an embodiment of the current invention;

FIG. 22 is a user interface example for the Evaluation Module according to an embodiment of the current invention;

FIG. 23 is a user interface example for the Compensation Module according to an embodiment of the current invention.

FIG. 24 is a user interface example for the Teaching Module according to an embodiment of the current invention;

FIG. 25 is a user interface example for the Report Module according to an embodiment of the current invention;

FIG. 26 is a user interface example for the Dashboard Module according to an embodiment of the current invention;

FIG. 27 is a user interface example for the Administration Module according to an embodiment of the current invention;

FIGS. 28-34 are user interface examples for the myPOWER Module according to an embodiment of the current invention;

FIG. 35 is an example for Enterprise Reporting according to an embodiment of the current invention;

FIGS. 36A-36N are detailed At Risk Goals including metric name, description, data elements, and additional descriptive information according to an embodiment of the current invention.

### DETAILED DESCRIPTION OF THE INVENTION

The current invention now will be described more fully hereinafter with reference to the accompanying drawings, which illustrate embodiments of the invention. This invention may, however, be embodied in many different forms and should not be construed as limited to the illustrated embodiments set forth herein. For example, the embodiments described herein are not limited to use in a health care environment. Rather, these embodiments are provided so that this disclosure will be thorough and complete, and will fully convey the scope of the invention to those skilled in the art.

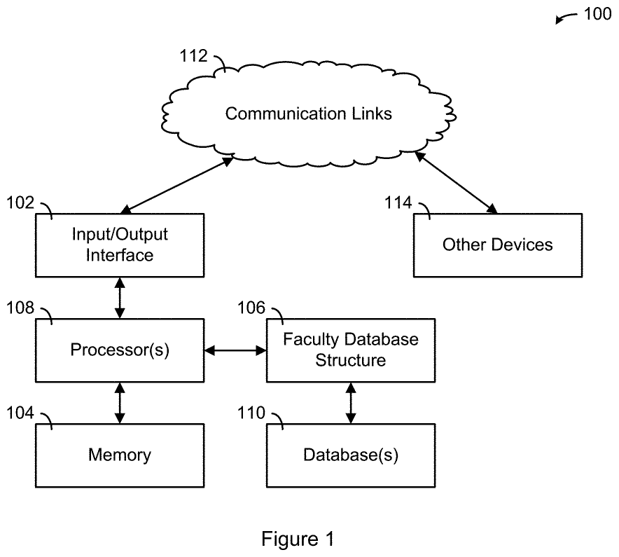

FIG. 1 is a block diagram of a system 100 for managing faculty resources in according to embodiment of the current invention. The system 100 includes an input/output interface 102, a memory 104, a faculty database structure 106, and one or more processors 108 communicably coupled to the input/output interface 102, the memory 104 and the faculty database structure 106. The memory 104 and/or database structure 106 can be local, remote or distributed. Likewise, the one or more processors 108 can be local, remote or distributed. The database structure 106 can be linked to and access data from one or more databases 110, which can be local, remote or distributed. The faculty database structure 106 includes a faculty profile for each faculty member (e.g., existing, past, prospective, etc.) that links personal data, position data, evaluation criteria (e.g., plans, key performance indicators (KPI), benchmarks, efforts, etc.), and performance data (e.g., clinical, administrative, compensation, grant management, teaching, productivity results, etc.) together for the faculty member. The database structure 106 improves the operation and performance of the system 100 by linking disparate data stored in the one or more databases 110 together into a central user interface 102. The input/output interface 102 can be any mechanism for facilitating the input and/or output of information (e.g., web-based interface, touchscreen, keyboard, mouse, display, printer, etc.) Moreover, the input/output interface 102 can be a remote device communicably coupled to the one or more processors 108 via one or more communication links 112 (e.g., network(s), cable(s), wireless, satellite, etc.). The one or more communication links 112 can communicably couple the system 100 to other devices 114 (e.g., databases, remote devices, hospitals, doctors, researchers, patients, etc.). The system 100 can be implemented with various devices, such as, server computers, workstation computers, laptop computers, mobile communications devices, personal data assistants, scanning devices or any other devices capable of performing the functions described herein. Note also that the system 100 may include other components not specifically described herein. The one or more processors 108 receive one or more of the faculty profiles selected via the input/output interface 102, determine a performance score for each selected faculty profile by comparing the performance data to the evaluation criteria, and provide the performance score for each selected faculty profile to the input/output interface 102. The system 100 accesses, utilizes, links, hosts, and secures disparate data systems (e.g., electronic medical records, financial records, clinical records, etc.) to manage faculty resources in ways described below that cannot be practically performed in the human mind.

The faculty member can be an existing, past or prospective faculty member. The evaluation criteria can be plans, key performance indicators (KPI), benchmarks, or efforts. The performance data can be clinical, administrative, compensation, grant management, teaching or productivity results. In one aspect, the one or more processors update the faculty profile with the performance score. In another aspect, the one or more processors compare the performance score of one faculty member to another performance score of one or more other faculty members. In another aspect, the one or more processors determine a management recommendation based on the performance score. In another aspect, the management recommendation comprises a hiring, terminating, promoting, disciplining, coaching or retaining recommendation. In another aspect, the one or more processors automatically send the management recommendation to a device of the selected faculty member. In another aspect, the one or more processors display the management recommendation on a visual enabled device comprising at least one of a computer, a smart phone, or tablet. In another aspect, the one or more processors automatically calculate a salary incentive for the faculty member. In another aspect, the one or more processors automatically calculate a teaching effort for the faculty member. In another aspect, the one or more processors automatically calculate compensation and an associated incentive for a new faculty member. In another aspect, the one or more processors associate two or more faculty profiles with a team. In another aspect, the faculty profiles and the one or more databases using a single security model. In another aspect, the personal data comprises at least one unique identifier comprising a faculty name, social security number, employee ID number, or faculty title. In another aspect, the faculty further comprises historical or legacy data for aggregate, time-point, or benchmark comparisons with the historical or legacy data of one or more faculty members. In another aspect, the one or more processors display at least one of a metric, a recommendation or a faculty profile comparison in a dashboard format on one or more devices.

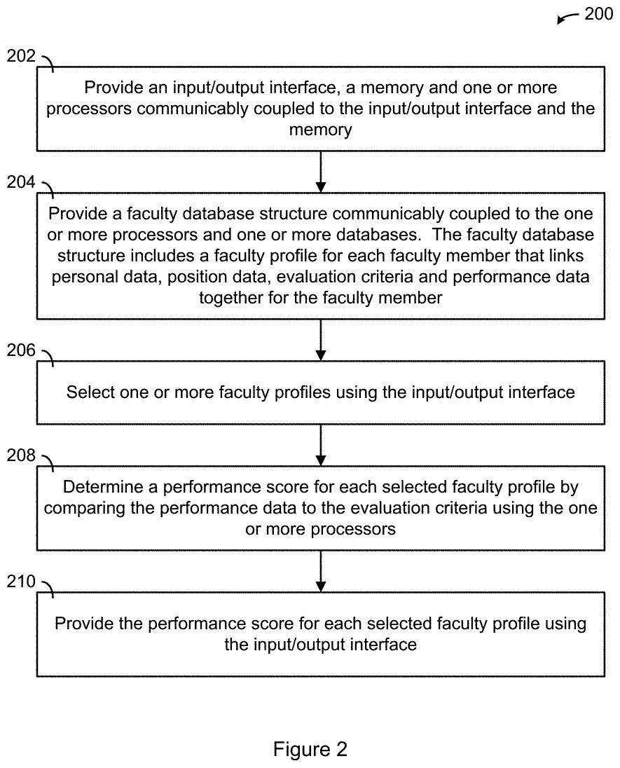

FIG. 2 is a flow chart 200 for managing faculty resources according to an embodiment of the present invention. An input/output interface, a memory, and one or more processors communicably coupled to the input/output interface and the memory are provided in block 202. A faculty database structure communicably coupled to the one or more processors and one or more databases is provided in block 204. The faculty database structure includes a faculty profile for each faculty member (e.g., existing, past, prospective, etc.) that links personal data, position data, evaluation criteria (e.g., plans, key performance indicators (KPI), benchmarks, efforts, etc.), and performance data (e.g., clinical, administrative, compensation, grant management, teaching, productivity results, etc.) together for the faculty member. One or more of the faculty profiles are selected using the input/output interface in block 206. A performance score for each selected faculty profile is determined by comparing the performance data to the evaluation criteria using the one or more processors in block 208. The performance score for each selected faculty profile is provided to the input/output interface in block 210.

The faculty member can be an existing, past or prospective faculty member. The evaluation criteria can be plans, key performance indicators (KPI), benchmarks, or efforts. The performance data can be clinical, administrative, compensation, grant management, teaching or productivity results. In one aspect, the method updates the faculty profile with the performance score. In another aspect, the method compares the performance score of one faculty member to another performance score of one or more other faculty members. In another aspect, the method determines a management recommendation based on the performance score. In another aspect, the management recommendation comprises a hiring, terminating, promoting, disciplining, coaching or retaining recommendation. In another aspect, the method automatically sends the management recommendation to a device of the selected faculty member. In another aspect, the method displays the management recommendation on a visual enabled device comprising at least one of a computer, a smart phone, or tablet. In another aspect, the method automatically calculates a salary incentive for the faculty member. In another aspect, the method automatically calculates a teaching effort for the faculty member. In another aspect, the method automatically calculates compensation and an associated incentive for a new faculty member. In another aspect, the method associates two or more faculty profiles with a team. In another aspect, the method protects the faculty profiles and the one or more databases using a single security model. In another aspect, the personal data comprises at least one unique identifier comprising a faculty name, social security number, employee ID number, or faculty title. In another aspect, the faculty further comprises historical or legacy data for aggregate, time-point, or benchmark comparisons with the historical or legacy data of one or more faculty members. In another aspect, the method displays at least one of a metric, a recommendation or a faculty profile comparison in a dashboard format on one or more devices.

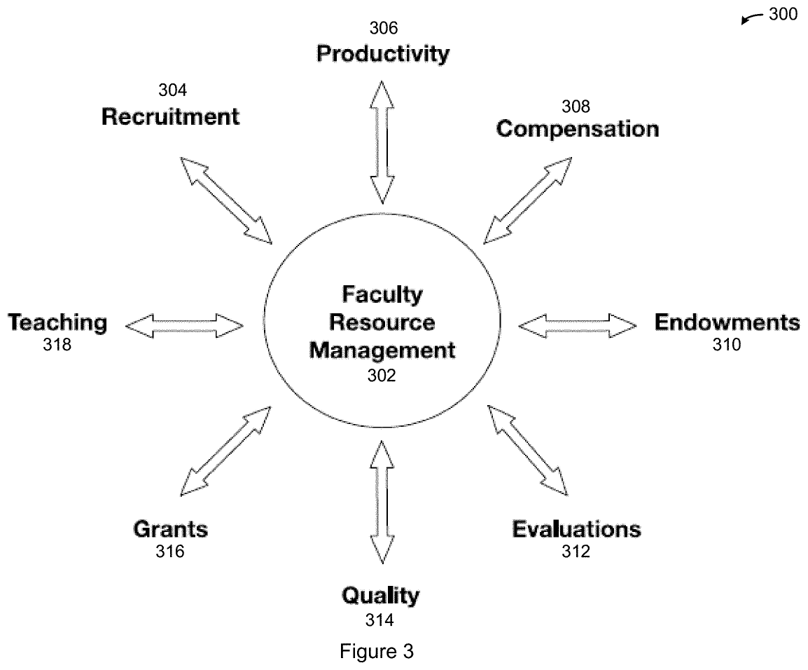

FIG. 3 is a hub and spoke diagram 300 outlining some data components and related modules of the method and system according to an embodiment of the current invention. The systems and methods for centralized data capture, aggregation, compilation, and reporting provide faculty resource management 302 as it pertains to recruitment 304, productivity 306, compensation 308, endowment procurement 310, evaluation 312, quality 314, grant procurement 316 and teaching 318 for a faculty, group of faculty and/or faculty candidate(s). Further embodiments of the current invention provide a plurality of data and data analyses to support administrators to effectively and efficiently make decisions on all aspect of the maintenance of the faculty pool and candidates that may make up a faculty pool.

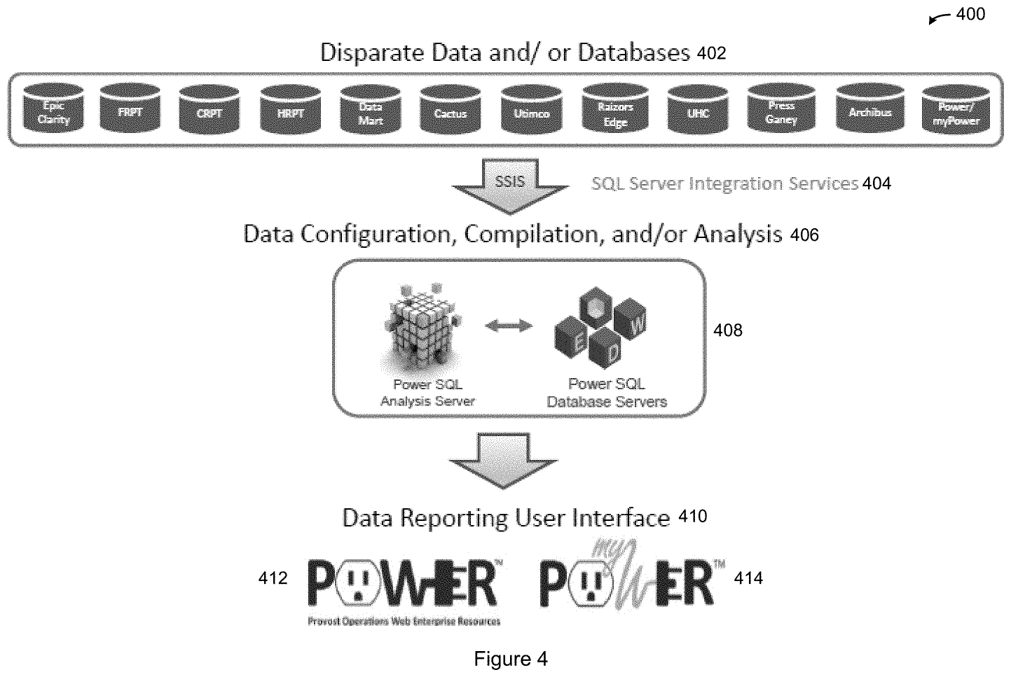

FIG. 4 illustrates embodiments of the current invention 400 where disparate data systems and/or databases 402 such as, but not limited to, financial, quality, human resource data systems and/or databases, are utilized by way of SQL Server Integration Services (SSIS) 404. Examples of such data systems and/or databases 402 include, but are not limited to: Epic Clarity, FRPT, CRPT, HRPT, Data Mart, Cactus, Utimco, Raizors Edge, UHC, Press Ganey, Archibus and POWER/myPOWER. The data systems and/or databases 402 are integrated into a centralized (cloud hosted or on-prem) server or servers 408 (e.g., Power SQL Analysis Server, Power SQL Database Servers, etc.) for aggregation, configuration, compilation, and/or analysis. The data from the disparate systems, through the further embodiments of the current invention provides a plurality of data configurations, automated queries, and/or algorithms to summarized and report a plurality of data results, actions, trends, predictions, and or recommendations via the internet-based software and user interfaces 410 known as POWER 412 and myPOWER 414. In a further embodiment, the data and data analyses are protected under a single security model.

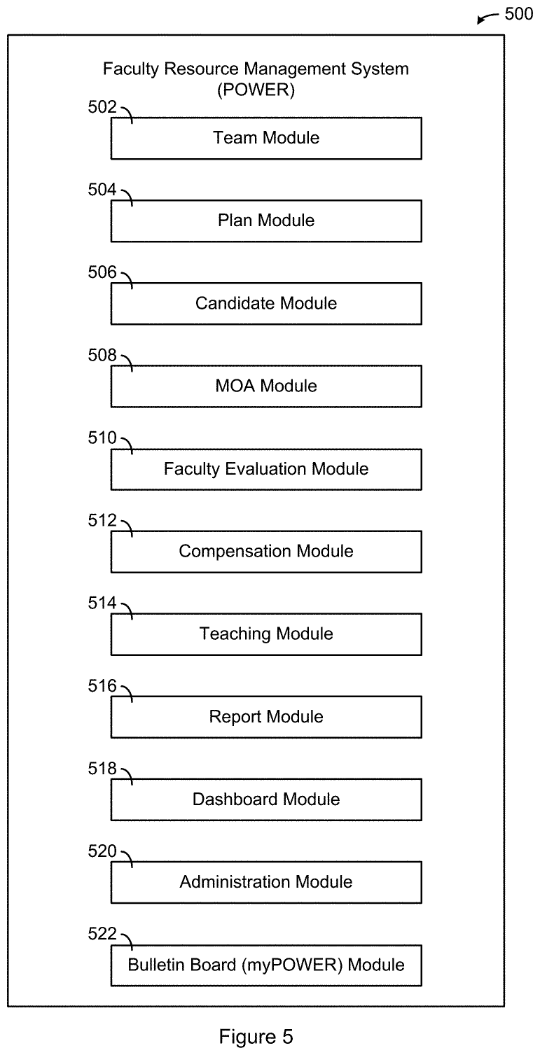

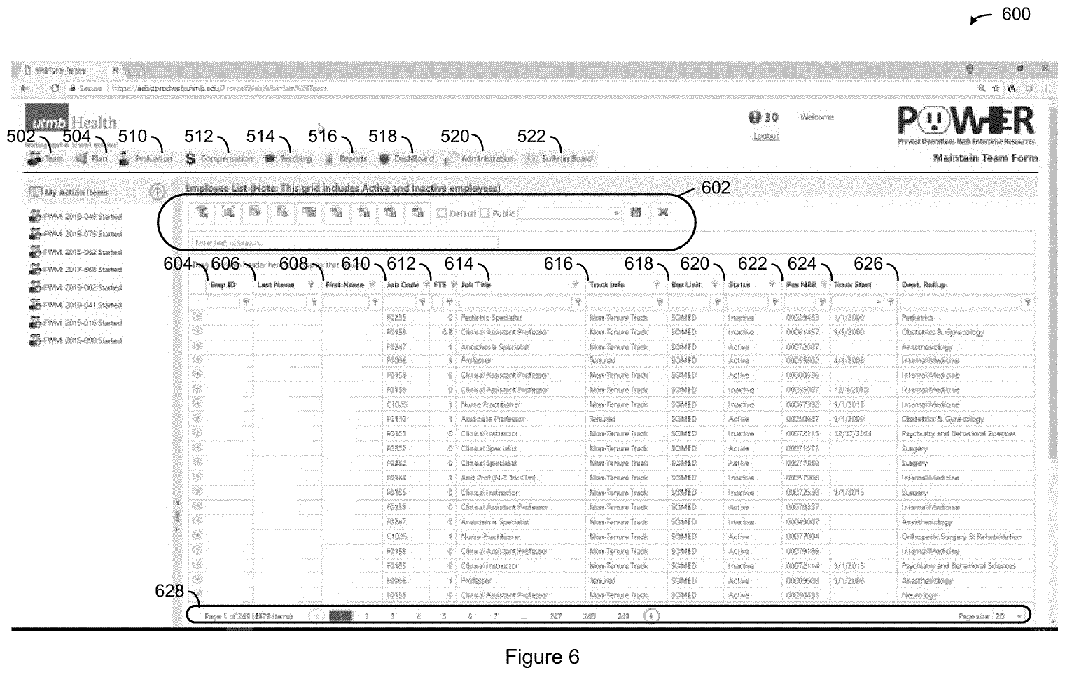

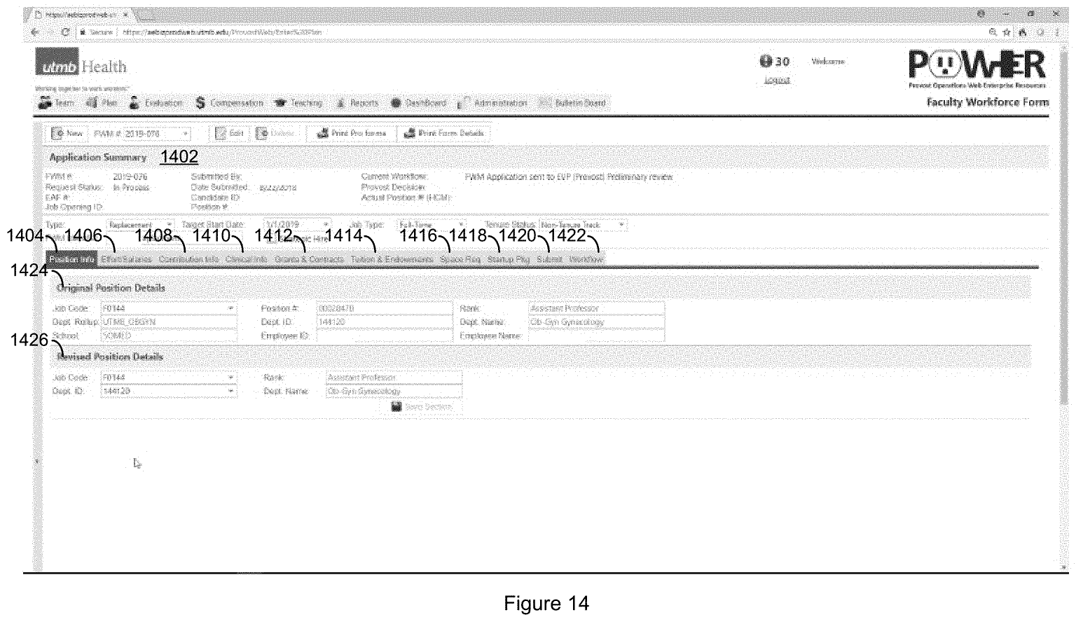

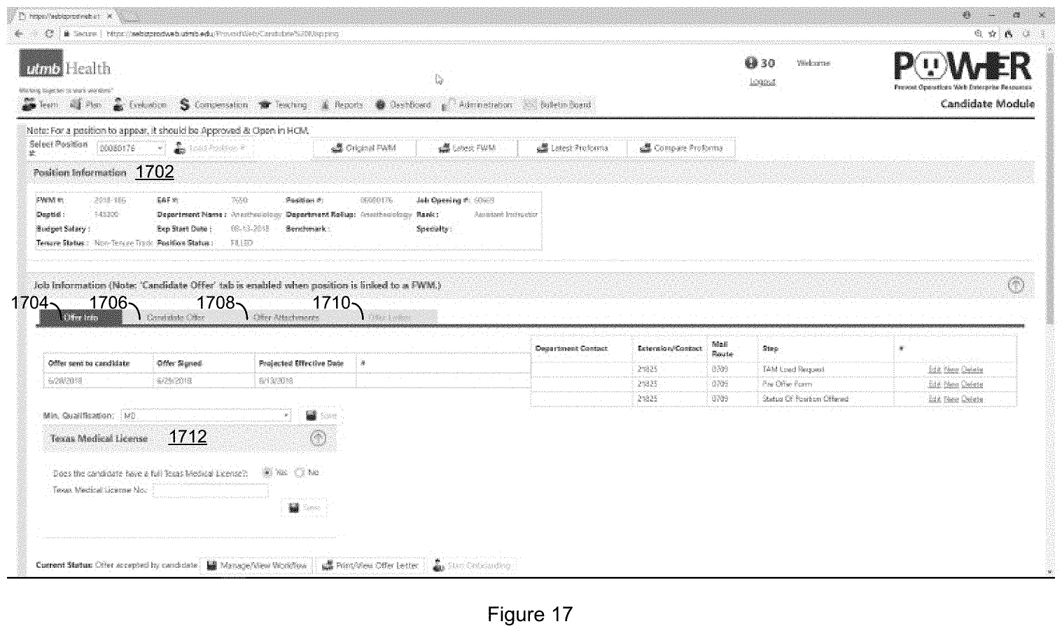

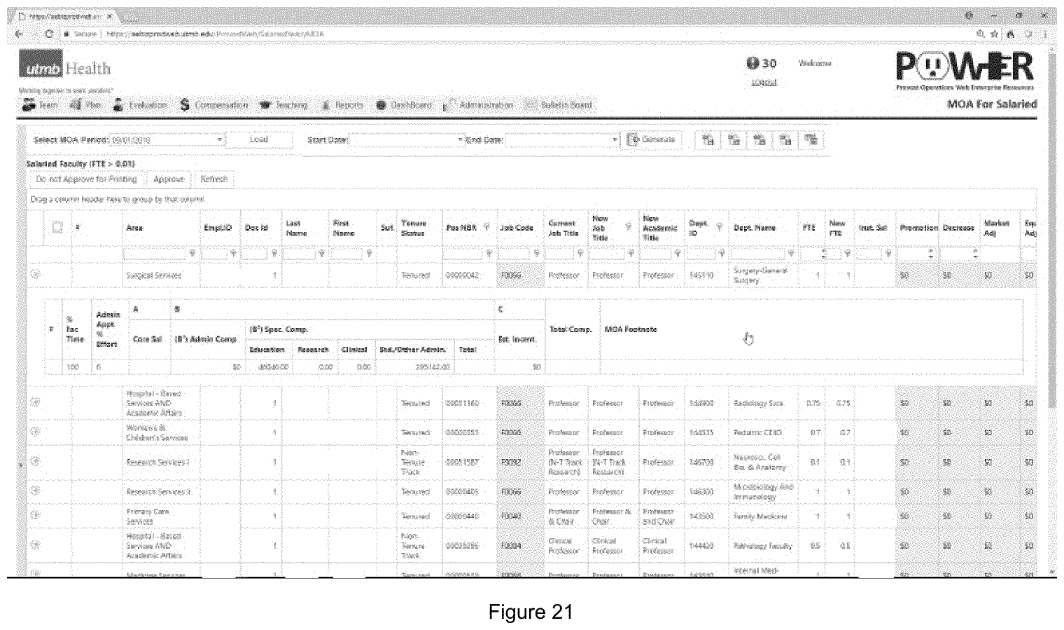

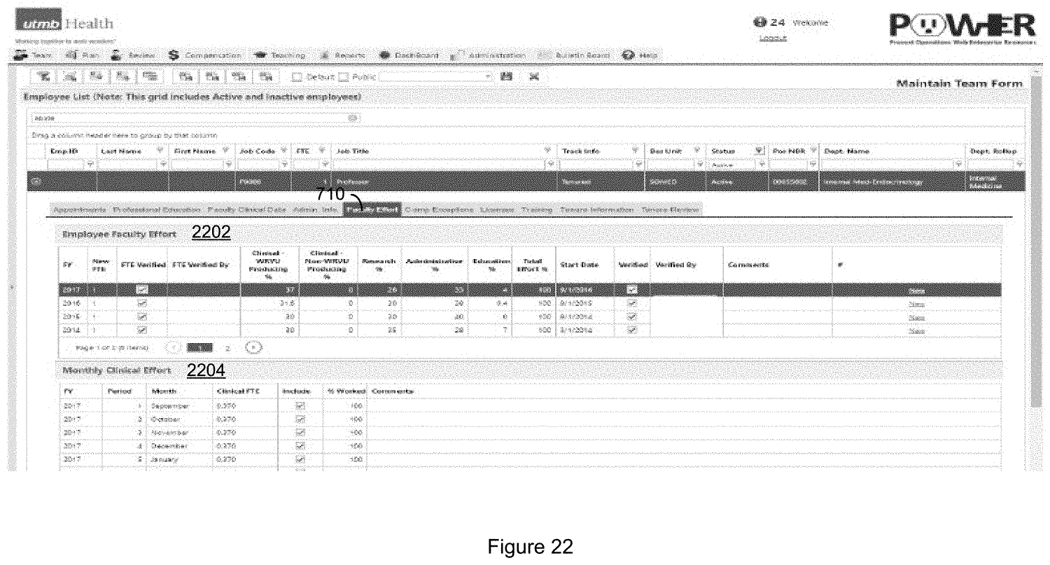

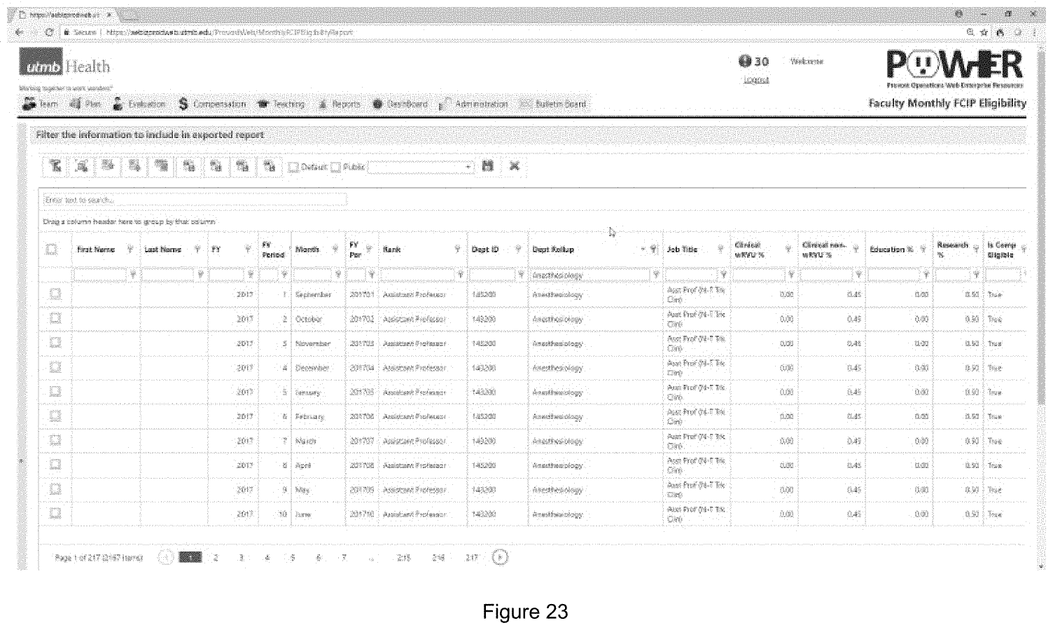

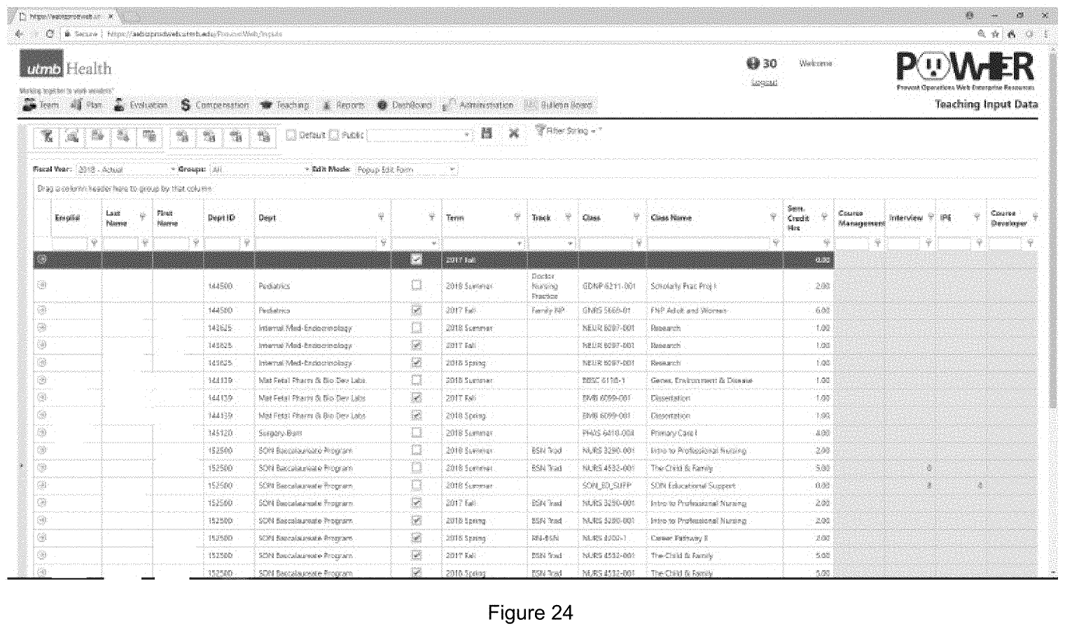

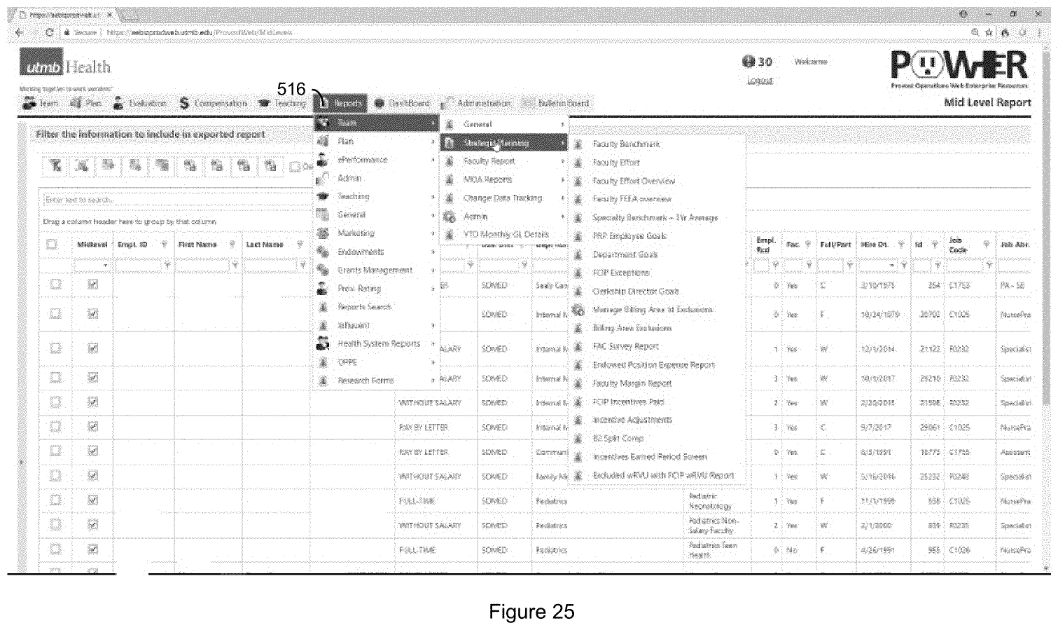

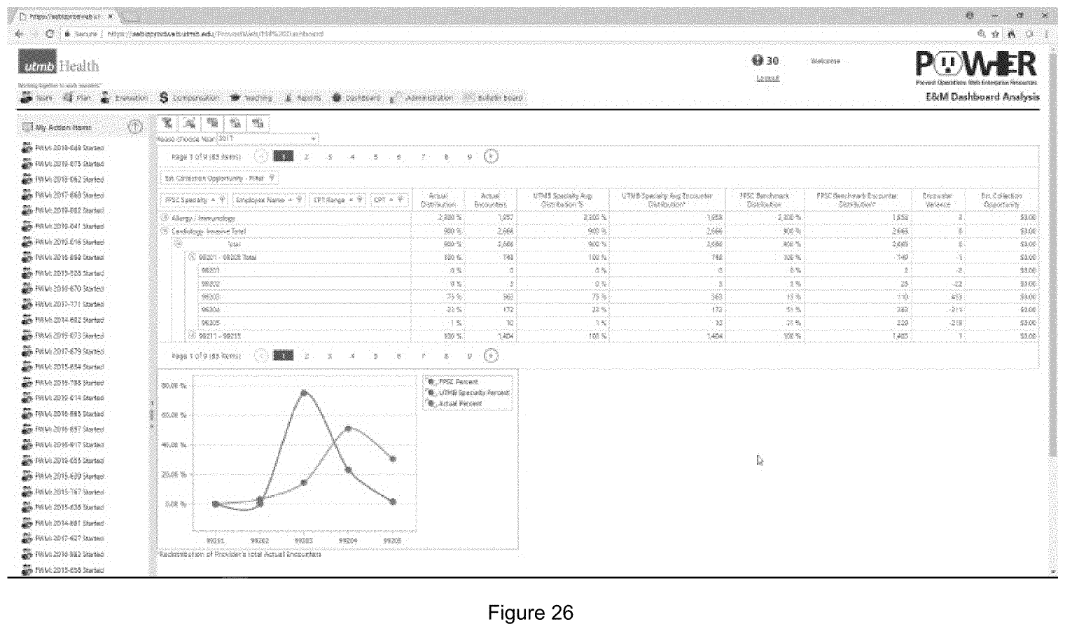

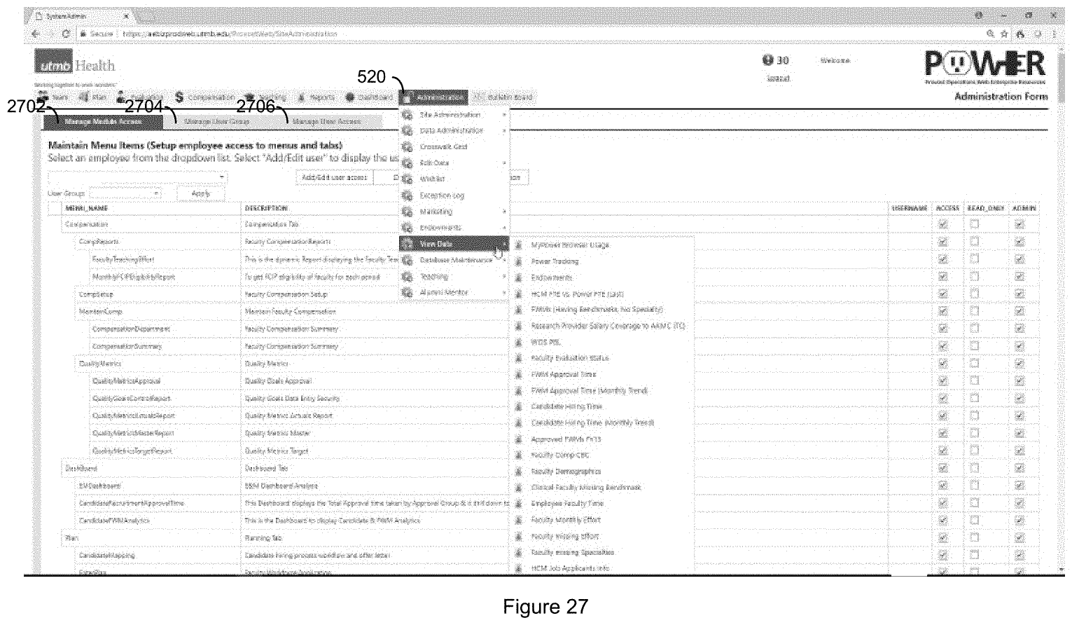

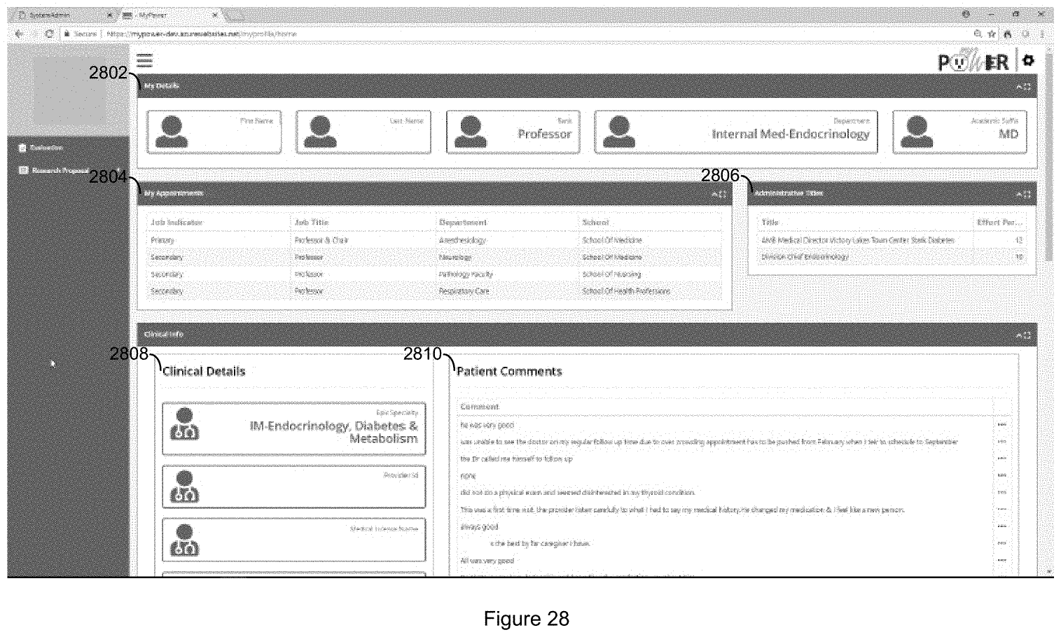

FIG. 5 is a block diagram illustrating various modules of a faculty resource management system 500 in accordance with an embodiment of the current invention. The data and data analyses shown in FIG. 4 are constructed into a series of functionally specific modules including, but not limited to: Team Module 502 (FIGS. 6-13), Plan (Recruitment) Module 504 (FIGS. 14-16), Candidate Module 506 (FIGS. 17-20), MOA Module 508 (FIG. 21), Faculty Evaluation Module 510 (FIG. 22), Compensation Module 512 (FIG. 23), Teaching Module 514 (FIG. 24), Report Module 516 (FIG. 25), Dashboard Module 518 (FIG. 26), Administration Module 520 (FIG. 27), and Bulletin Board (myPOWER) Module 522 (FIGS. 28-34).

FIGS. 6-35 illustrate various display screens for an embodiment of the current invention. The screens include navigation tabs that access various modules: Team Module 502, Plan (Recruitment) Module 504, Faculty Evaluation Module 510, Compensation Module 512, Teaching Module 514, Report Module 516, Dashboard Module 518, Administration Module 520, and Bulletin Board (myPOWER) Module 522. The screens also provide various buttons and fields 602 that perform various data functions. Other navigation tools and data functions can be used. Note that the actual names, photos, financial information and other confidential information have been removed from the Figures.

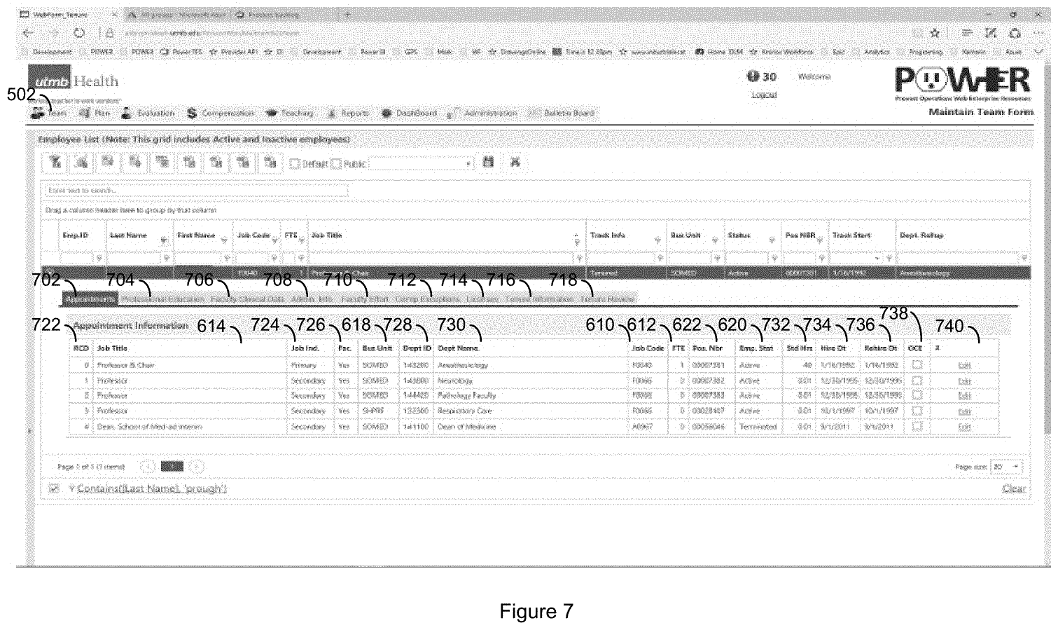

FIGS. 6-13 illustrate the Team Module 502 of an embodiment of the current invention. FIGS. 6 and 7 illustrate the team overview 600 that includes, but is not limited to, team member or employee ID 604, last name 606, first name 608, job code 610, FTE assignment 612, job title 614, track info 616, business unit 618, status 620, position number 622, tenure start 624 and department rollup 626. Other data fields and information can be used. The data fields are searchable and sortable. Data page navigation tools 628 are also provided. As shown in FIG. 7, various details about a faculty member are available when the faculty member is selected. The following navigation tabs are provided: Appointments 702, Professional Education 704, Faculty Clinical Data 706, Admin. Info. 708, Faculty Effort 710, Comp Exceptions 712, Licenses 714, Tenure Information 716 and Tenure Review 718. The Appointments tab 702 provides RCD 722, job title 614, job indicator 724, faculty 726, business unit 618, department ID 728, department name 730, job code 610, FTE assignment 612, position number 622, employment status 620, standard hours 732, hire date 734, rehire date 736, OCE 738 and edit tool 740.

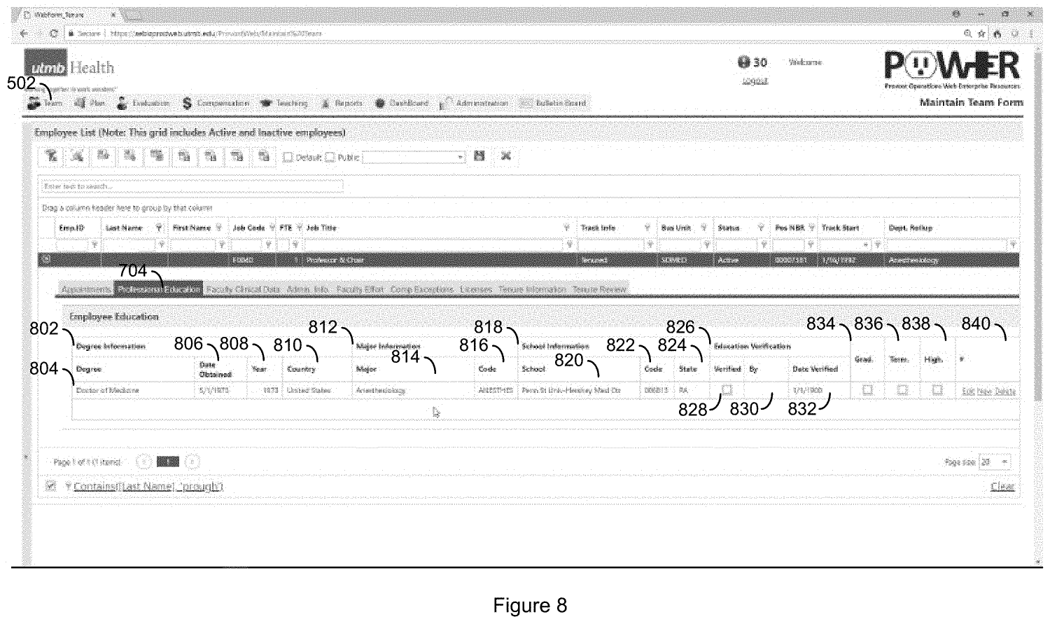

In one embodiment of the current invention, the data captured and reported in the Team Module can be aggregated and de-aggregated for analysis purposes. For example the total FTE assignments for team individuals can be aggregated to analyze and determine project goals and objectives. FIG. 8 illustrates an embodiment of the current invention that provides details regarding a team member's (faculty) credentials via the Profession Education tab 704, including but not limited to, schools attended, attendance dates, graduation dates, and degrees received. For example, degree information 802 (degree name 804, date obtained 806, year 808, country 810), major information 812 (major name 814, major code 816), school information 818 (school name 820, school code 822, state 824), education verification 826 (verified check box 828, verifier name 830, date verified 832), grad check box 834, term check box 836, high check box 838, and edit/new/delete tools 840. This data and data presentation is foundational to recruitment and hiring activities. In another embodiment of the current invention this credentialing data is compared to a credentialing benchmark or preset metrics to provide guidance and recommendations for recruitment, hiring, promoting, and termination decisions.

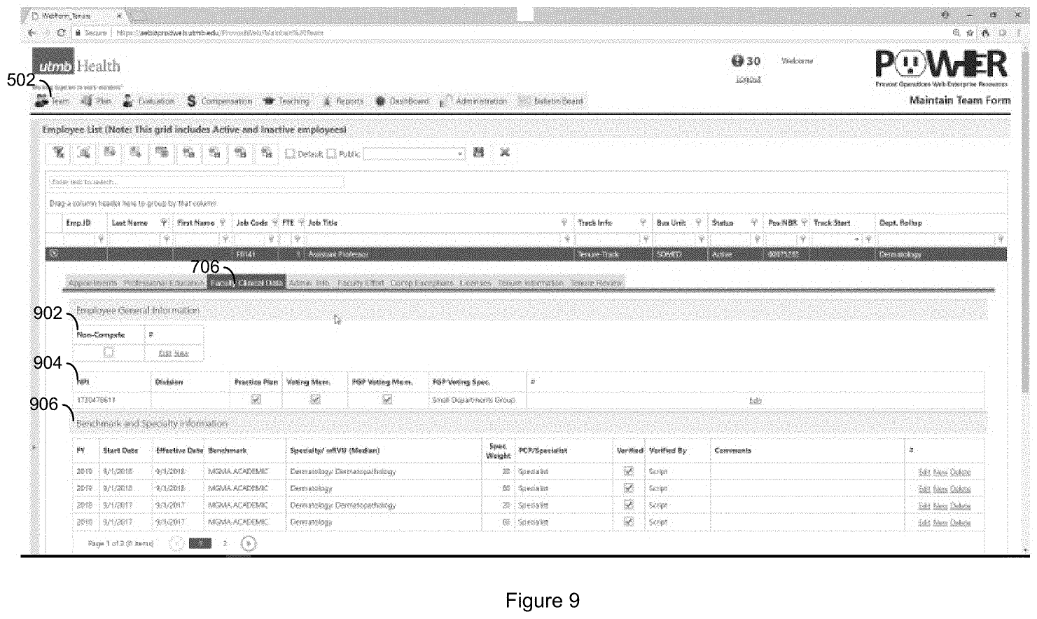

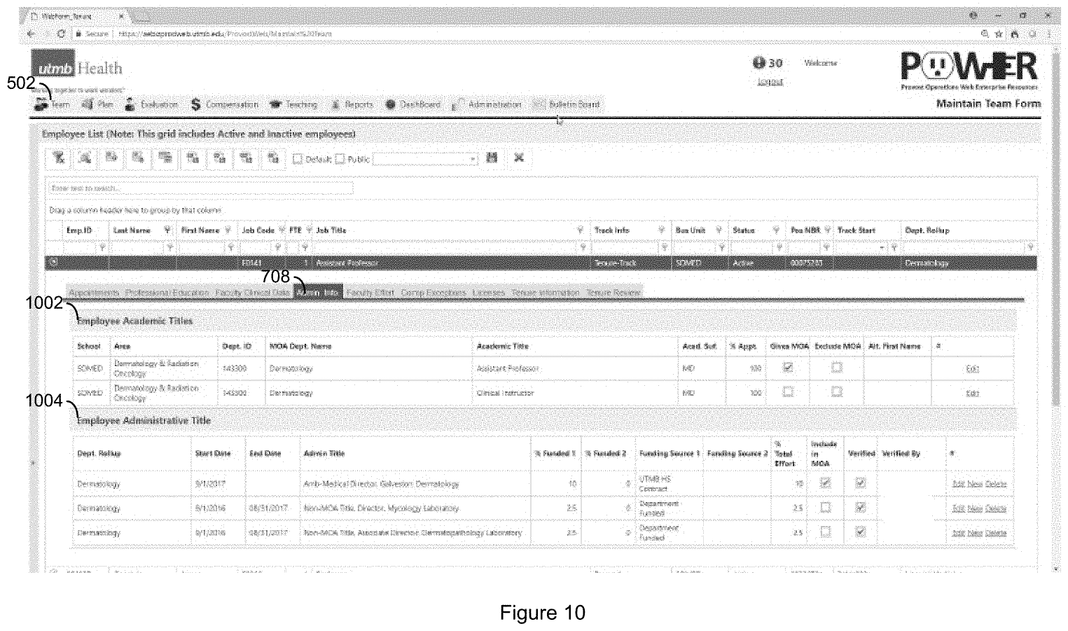

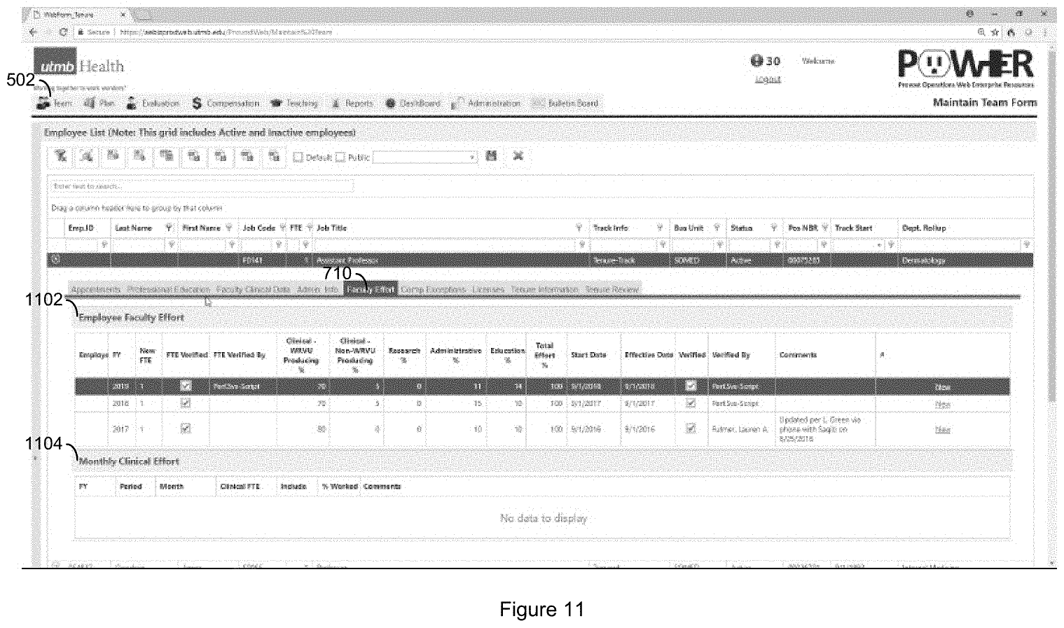

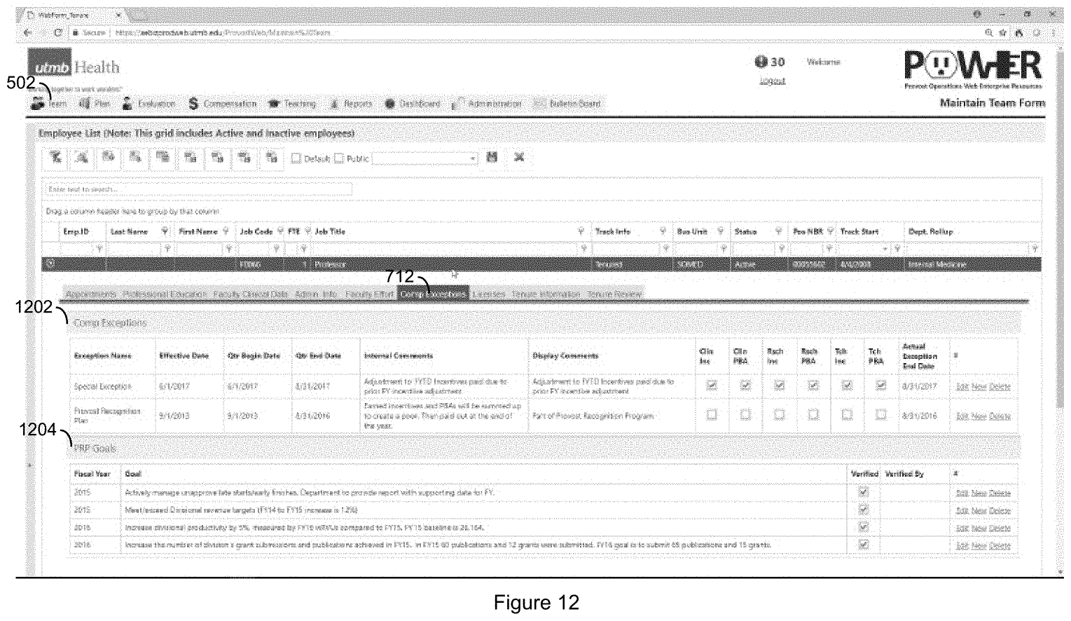

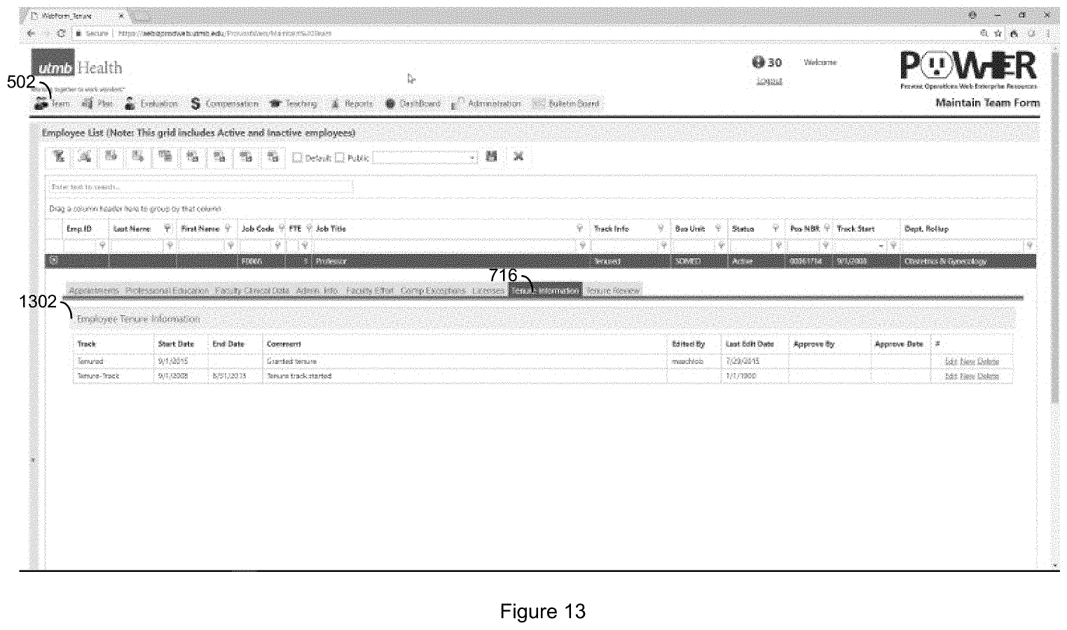

FIG. 9 illustrates an embodiment of the current invention that provides systems and methods for faculty employment and administration information analysis (Faculty Clinical Data tab 706), including but not limited to, status of a non-disclosure agreements (NDA), non-competes (NC) 902, voting rights status, and benchmark and specialty information 904. In another embodiment of the current invention, digital copies of these documents are available for view via hyperlink and/or embedded PDF document. FIG. 10 illustrates an embodiment of the current invention that provides summation of faculty funding sources and percentage of funding sources comprising the faculty's compensation (Admin Info tab 708). For example, listing employee academic titles 1002 and employee administrative titles 1004. FIG. 11 illustrates an embodiment of the current invention that provides aggregated and de-aggregated details on the faculty's work effort categorized by work function (Faculty Effort tab 710), including but not limited to, education, administration, and research. For example, employee faculty effort 1102 and monthly clinical effort 1104. FIG. 12 illustrates embodiments of the current invention that provide systems and methods for analysis of faculty compensation records and actions (Comp Exceptions tab 712). For example, compensation exceptions 1202 and PRP goals 1204. FIG. 13 illustrate embodiments of the current invention that provide systems and methods for analysis of faculty details on tenure (Tenure Information tab 716). For example, employee tenure data 1302. The data and data presentation within the Team Module provides great power to administrators to review, comment, and make recommendations on current faculty and/or faculty candidates.

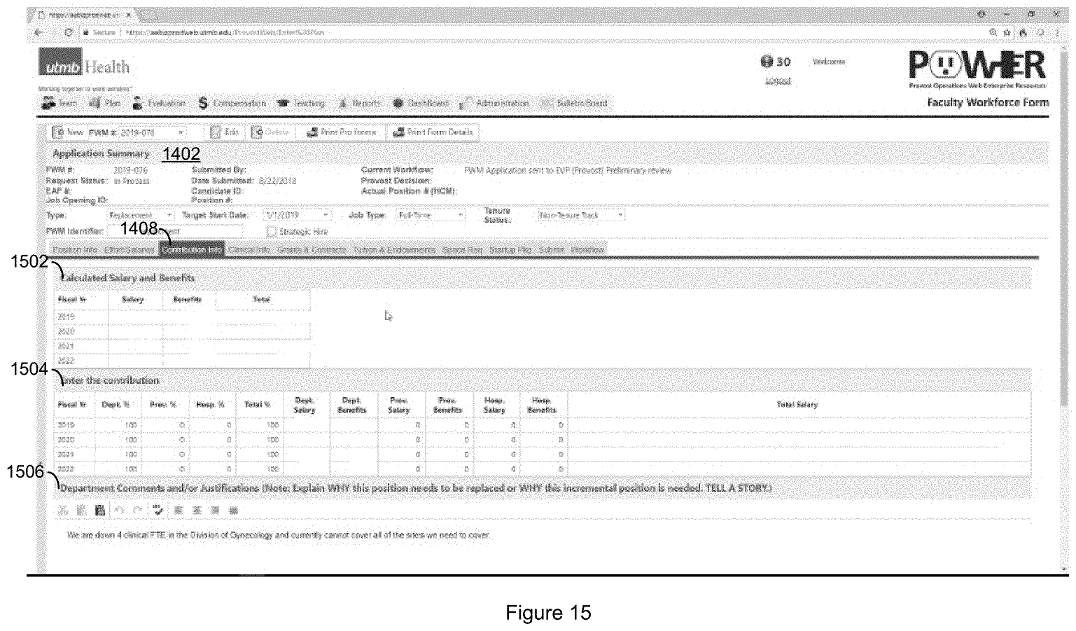

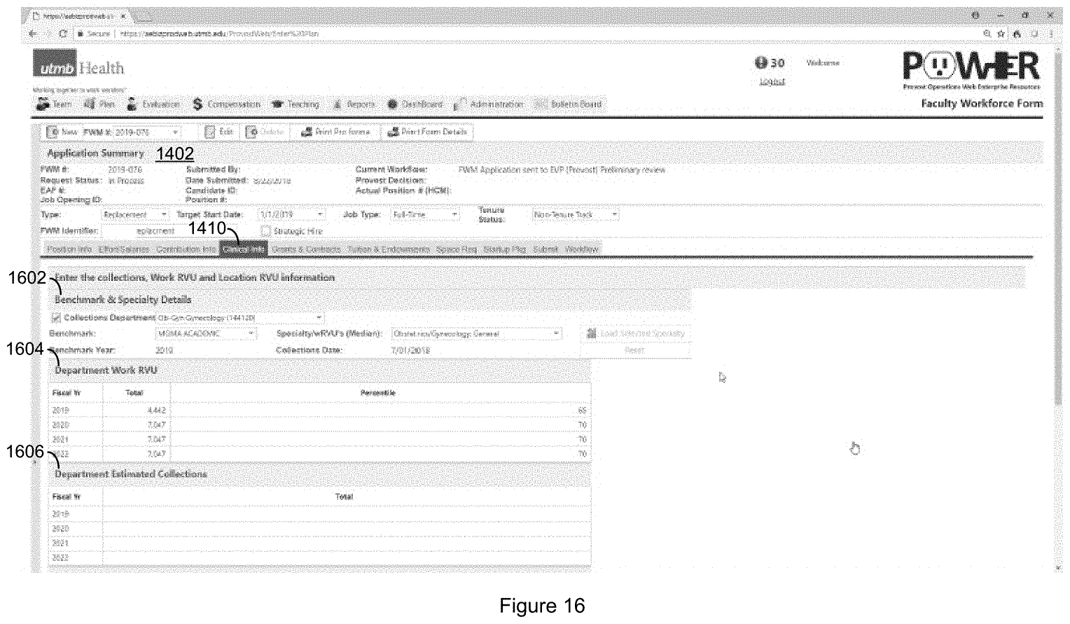

FIGS. 14-16 illustrate the Plan (Recruitment) Module of an embodiment of the current invention. This module provides embodiments of the current invention that are critical to the hiring and promoting functions of the faculty resource management systems and methods. These embodiments include but not limited to, application summary, position status, position type, original position details, revised position details, salary/benefits history and range, RVU targets and past RVU targets and actuals. Navigation tabs may include Position Info 1404, Effort/Salaries 1406, Contribution Info 1408, Clinical Info 1410, Grants & Contracts 1412, Tuition & Endowments 1414, Space Req 1416, Startup Pkg 1418, Submit 1420 and Workflow 1422. FIG. 14 illustrates the applicant history 1402 and Position Info tab 1406. FIG. 14 illustrates the applicant history 1402 and Position Info tab 1404. The Position Info tab 1404 includes original position details 1424 and revised position details 1426. FIG. 15 illustrates the applicant history 1402 and Contribution Info tab 1408. The Contribution Info tab 1408 includes calculated salary and benefits 1502, contribution entry data 1504, and department comments and/or justifications 1506 (i.e., Explain why this position needs to be replaced or why this incremental position is needed). FIG. 16 illustrates the applicant history 1402 and Clinical Info tab 1410. The Clinical Info tab 1410 includes benchmark and specialty details 1602, department work RVU 1604 and department estimated collections 1606. In one embodiment of the current invention, pairing algorithms, machine learning and/or artificial intelligence will be used to automatically pair candidates and positions based on specific criteria.

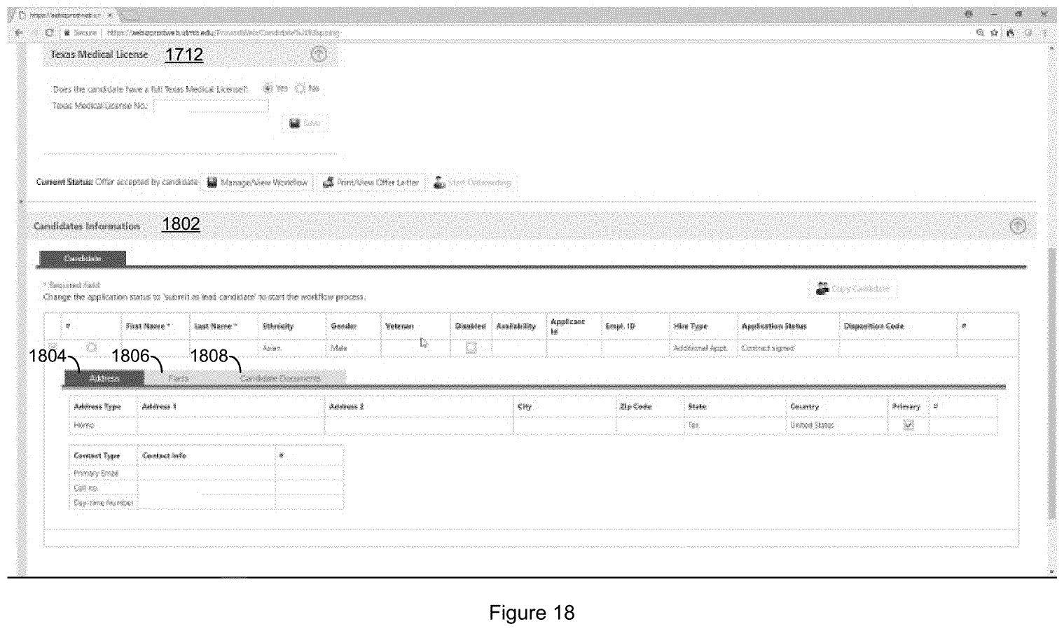

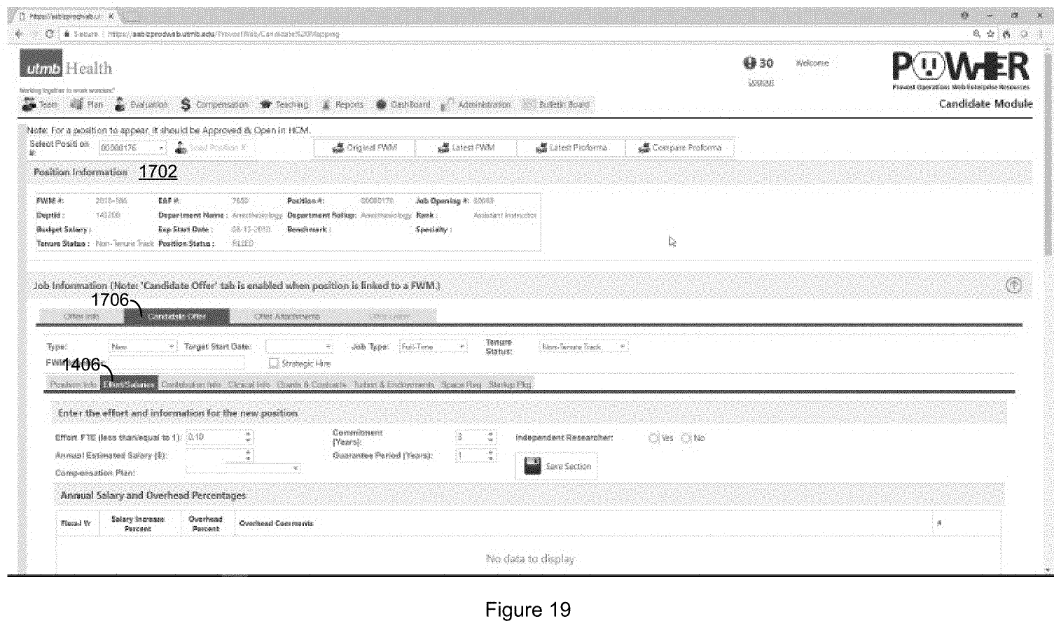

FIGS. 17-20 illustrate an embodiment of the current invention that provides a plurality of information about faculty candidates including but not limited to candidate demographics, candidate contact information, candidate credentials, resume, and/or CV. In another embodiment of the current invention, digital copies of faculty candidate documents will be provided and available for review via hyperlink and/or embedded PDF document. In a further embodiment of the current invention, pairing algorithms, machine learning, and/or artificial intelligence will use candidate information to automatically screen against faculty position criteria presented in the Plan (Recruitment) Module. In an embodiment, compensation and associated incentives for new faculty are automatically calculated. When a faculty member arrives at UTMB, Salary, effort, benchmark, specialty and mission effort data is automatically added to the team module. Navigation tabs may include Offer Info 1704, Candidate Offer 1706, Offer Attachments 1708 and Offer Letter 1710. FIG. 17 illustrates the position information 1702, Offer Info tab 1704 and Texas Medical License information 1712. FIG. 18 illustrates Texas Medical License information 1712 and Candidate Information 1802 with Address tab 1804, Facts tab 1806 and Candidate Documents tab 1808. FIG. 19 illustrates position information 1702 and Candidate Offer tab 1706 and Effort/Salaries tab 1406.

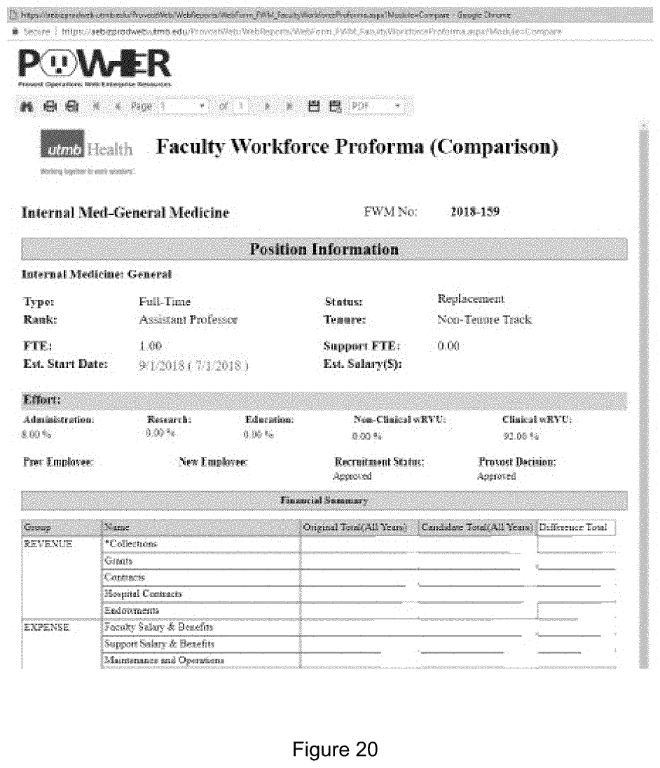

FIG. 20 illustrates an embodiment of the current invention that provides systems and methods for providing a candidate an offer of faculty employment. In a further embodiment of the current invention, when a faculty position outlined and illustrated in the Plan (Recruitment) Module is paired to a faculty candidate outlined and illustrated in the Candidate Module of the current invention the administrator will review the pairing and recommendations. Once the candidate is approved, an offer letter is automatically sent out to the candidate with salary and benefit details. Once the candidate accepts the position, human resource documentation is requested, collected, and administered via the user interfaces know as POWER and myPOWER. In another embodiment of the current invention, all hiring records, actions, and communications are recorded and documented.

FIG. 21 illustrates an embodiment of the invention that provides systems and methods for memorandums of agreement (MOA). MOAs are required at the beginning of each fiscal year, along with non-competes and FEEAs. In addition to an annual MOA for faculty, a new MOA is required when faculty salaries or effort changes, documented and tracked in other modules of the current invention, are made. Changes in FTE, administrative titles, mission effort, specialties and benchmarks also trigger an MOA. In another embodiment of the current invention, an MOA is also automatically generated and automatically sent to faculty to indicate changes in the aforementioned MOA triggering events including offer letters that are generated in our Candidate Module. The MOA also contains all salary calculations, including the compensation breakdown. A plurality of layouts is provided depending on input parameters including school, department, pay type and position. In another embodiment of the current invention, MOA communications, reviews, submissions and approvals are completed utilizing the user interfaces POWER and myPOWER.

FIG. 22 illustrates an embodiment of the current invention that provides systems and methods for faculty evaluations. Information from the Faculty Effort tab 710 is shown as Employee Faculty Effort 2202 and Monthly Clinical Effort 2204. This module is integrated with other modules of the current invention to document, track, and monitor position key performance indicators (KPIs) that have been developed and documented as part of the recruitment and hiring processes. These KPIs can be managed as discreet or objective metrics. In one embodiment of the current invention, the Faculty Evaluation Module is fully integrated with the Compensation Module to increase or decrease faculty compensation based on merit and effort. FIG. 23 illustrates another embodiment of the current invention that provides a detailed longitudinal record of faculty compensation based on performance criteria and/or KPIs outlined in the Faculty Evaluation Module. The compensation plan allows faculty to select clinical, research and education metrics associated with the faculty compensation plan. Selected metrics are used to calculate salary incentives for faculty. Various software processes with associated forms for collecting metrics are provided.

FIG. 24 illustrates an embodiment of the current inventions that provides systems and methods for analysis of faculty teaching history. This module provides detailed information, including but not limited to: faculty ID, department ID, course name, course ID, course credits, course material developer, and general comments. In another embodiment of the current invention, the Teaching Module and related information can be analyzed in combination with other modules and related information to purposes of faculty evaluation. The Teaching Module includes an advanced calculation engine for calculating teaching effort for faculty with education effort. This module has a unique web interface for entering required data. At the beginning of each semester, course coordinators enter projected course data for faculty. At the end of each semester, the data is converted to actuals and education effort automatically calculated.

FIG. 25 illustrates systems and methods for reporting configuration. In one embodiment of the current invention, the Report Module provides a plurality of custom report configurations, drawing data and data analyses results from other modules of the current invention. These custom report configurations available through the Report Module include, but are not limited to, text narrative descriptions, graphical data presentation, trend lines, statistical analysis, and predictive analytics. FIG. 26 illustrates systems and methods for providing data and data analyses from one or more modules of the current invention in a dashboard format. This Dashboard Module provides data and data analyses in a preset configuration for use in time dependent reporting such as, but not limited to monthly reports, quarterly reports, annual reports. In one embodiment of the current invention, the Dashboard Module will be used by administrators for faculty evaluation via the user interfaces POWER and myPOWER.

FIG. 27 illustrates systems and methods of an embodiment of the current invention that provide administrative access, configuration, and control of one or more modules of the current invention. For example, manage module access 2702, manage user group 2704 and manage user access 2706. In one embodiment of the current invention, the Administration Module is used to provide access to information, data, and data analyses to faculty and faculty administrators.

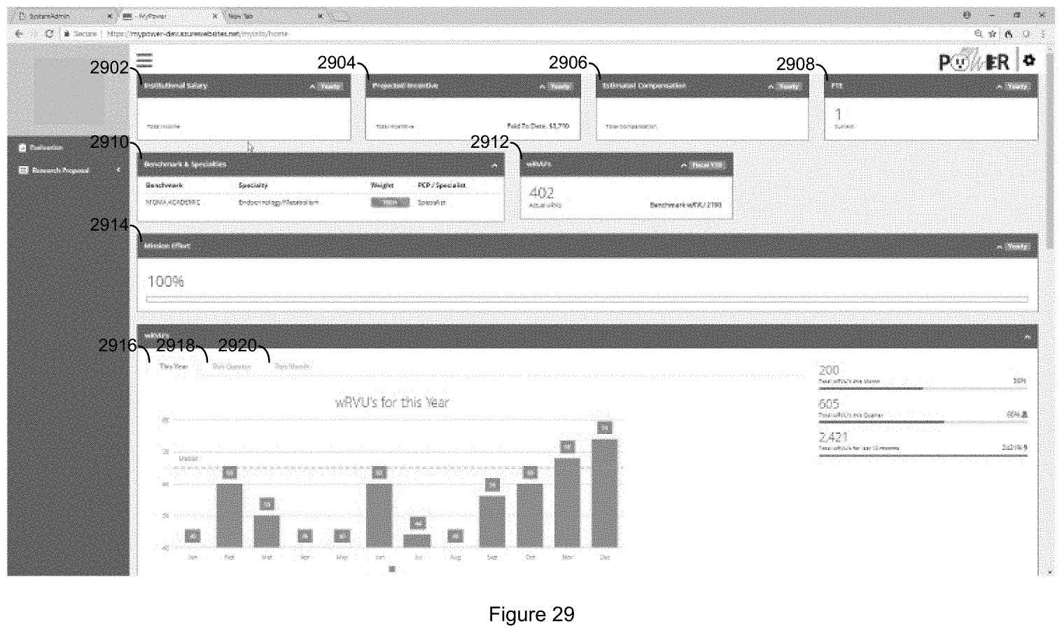

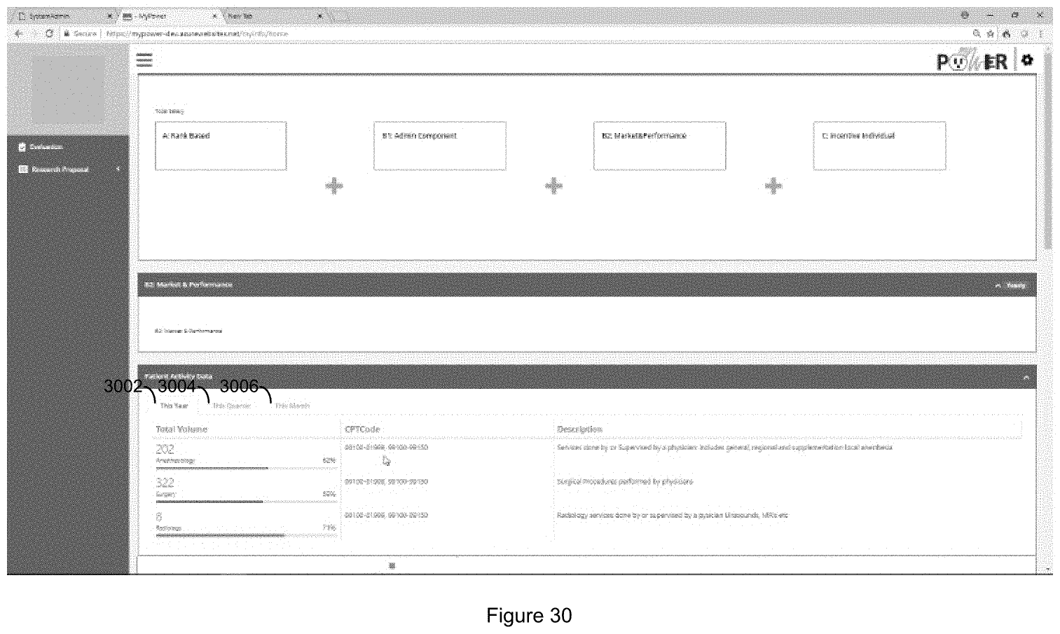

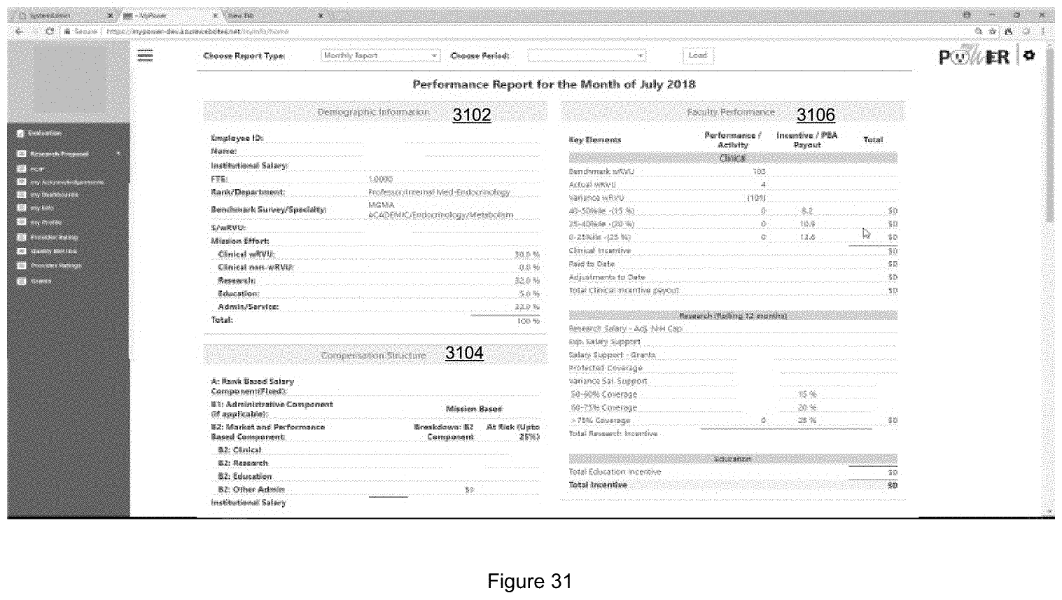

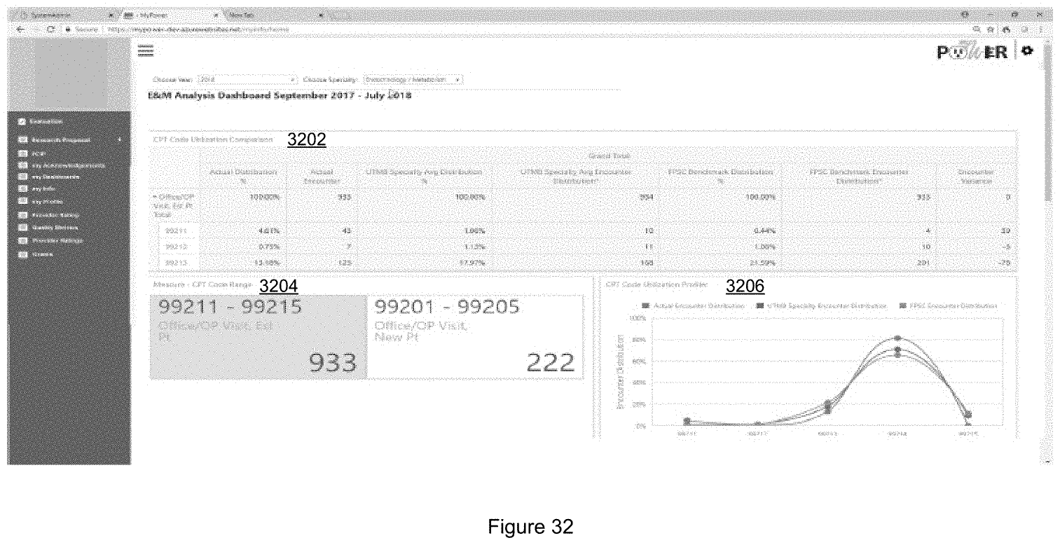

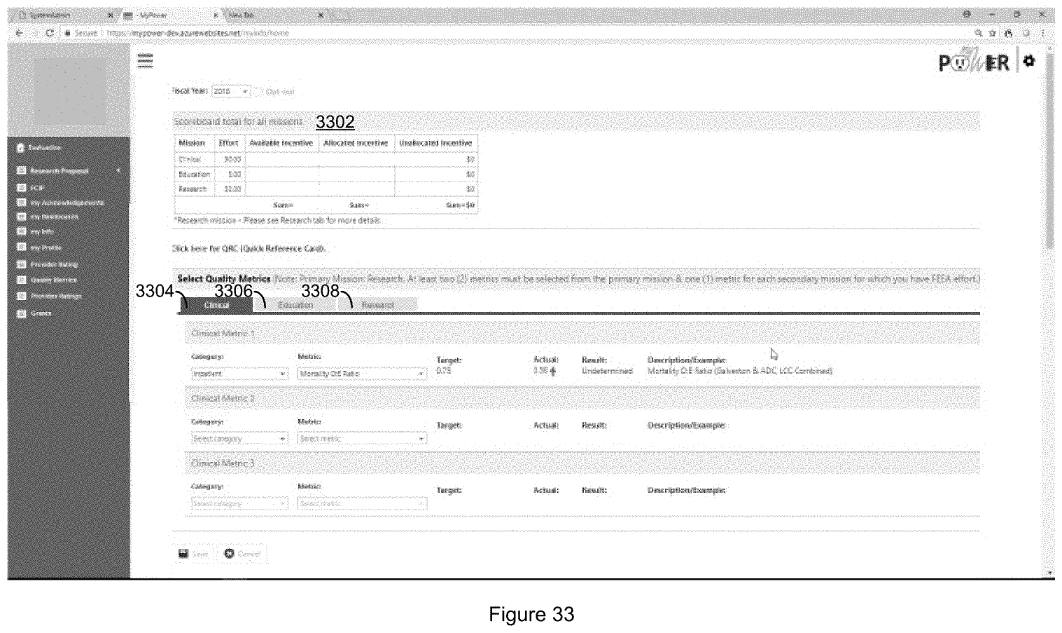

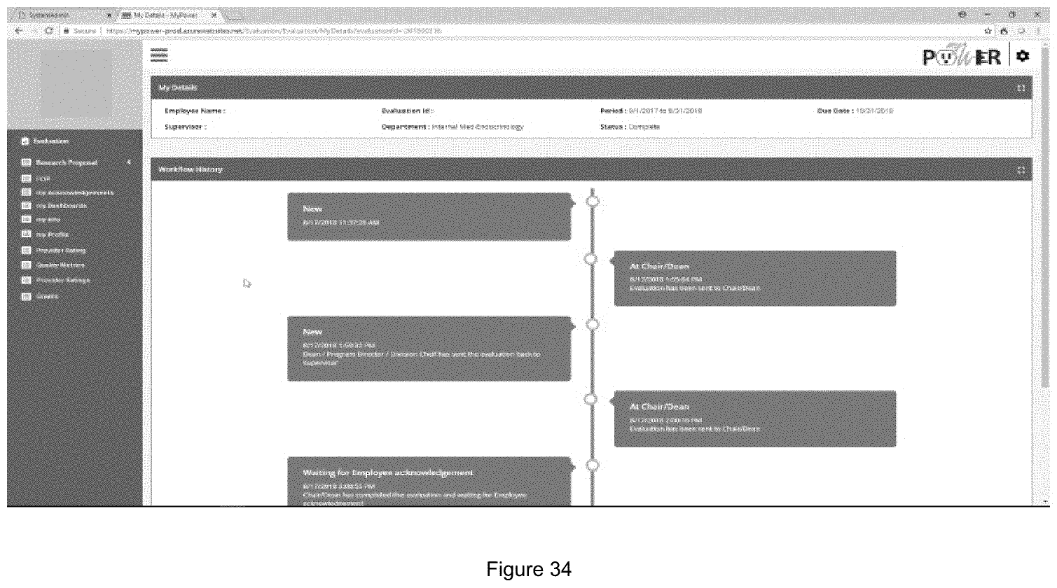

FIGS. 28-34 provide systems and methods for myPOWER. In one embodiment of the current invention, the myPOWER Module provides a faculty facing user interface that provides data and data analyses derived from other modules of the current invention. FIG. 28 provides a snapshot of the faculty demographics and contact information 2802, appointment 2804, administrative titles 2806, clinical details 2808, and patient comments 2810. FIG. 29 provides salary, incentive, and wRVU goals to actuals analyses over time. For example, institutional salary 2902, projected incentive 2904, estimated compensation 2906, PTE 2908, benchmark and specialties 2910, wRVUs 2912, mission effort 2914, wRVUs for this year 2916, this quarter 2918 and this month 2920. FIG. 30 provides detailed salary breakdown by function and patient activity (e.g., this year 3002, this quarter 3004 and this month 3006). FIG. 31 illustrates an example of a faculty monthly performance report. For example, demographic information 3102, compensation structure 3104 and faculty performance 3106. In one embodiment of the current invention, the monthly performance report will be utilized by administrators for faculty evaluation activities and coaching and/or mentoring opportunities. FIG. 32 illustrates and example of an E&M Dashboard for metrics analysis. For example, CPT code utilization comparison 3202, measure—CPT code range 3304 and graph of CPT code utilization preview 3306. FIG. 33 provides a breakdown of faculty clinical quality metrics and/or goals and the faculty's measure to that metric and/or goal. For example, a scoreboard total for all missions 3302, clinical quality metrics 3304, education quality metrics 3306 and research quality metrics 3308. FIG. 34 provides a faculty workflow history and timeline.

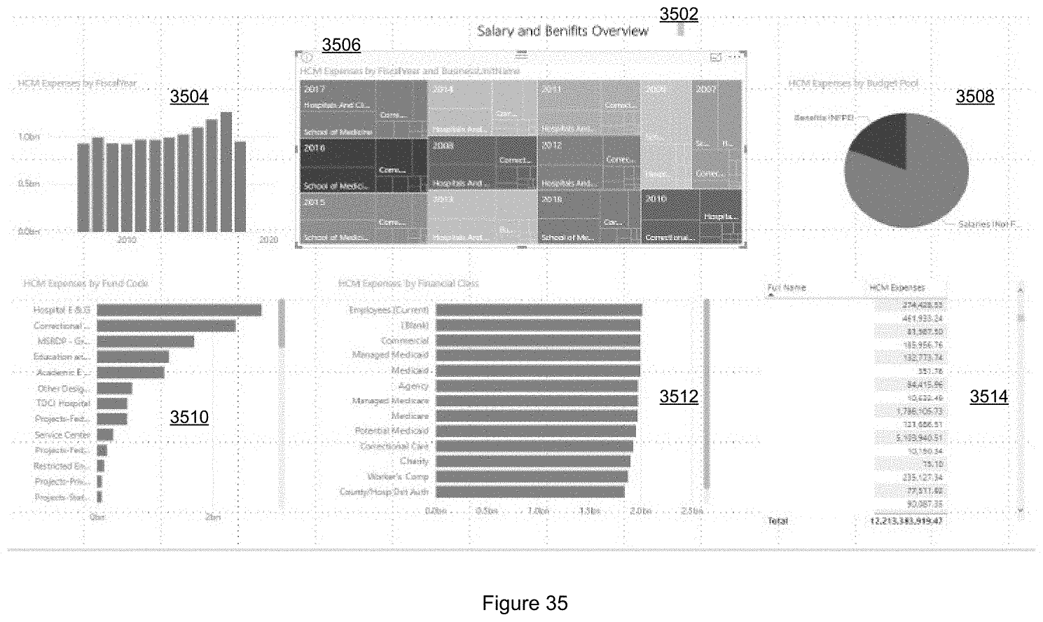

FIG. 35 illustrates systems and methods for enterprise reporting. The Enterprise Reporting Module provides data and data analyses on a plurality of measures, metrics, goals that are captured, calculated, assessed, and reported as an embodiment of the current invention. In one embodiment of the current invention, the components of the enterprise report can be aggregated and/or de-aggregated. The analysis can be captured, calculated, assessed, and reported at the individual faculty level, department level, facility level, hospital level, and/or system level. For example, a Salary and Benefits Overview 3502 may include a vertical bar chart of HCM expenses by fiscal year 3504, heat map of HCM expenses by fiscal year and business unit name 3506, pie chart of HCM expenses by budget pool 3508, horizontal bar chart of HCM expenses by fund code 3510, horizontal bar chart of HCM expenses by financial class 3512, and HCM expense by full name table 3514.

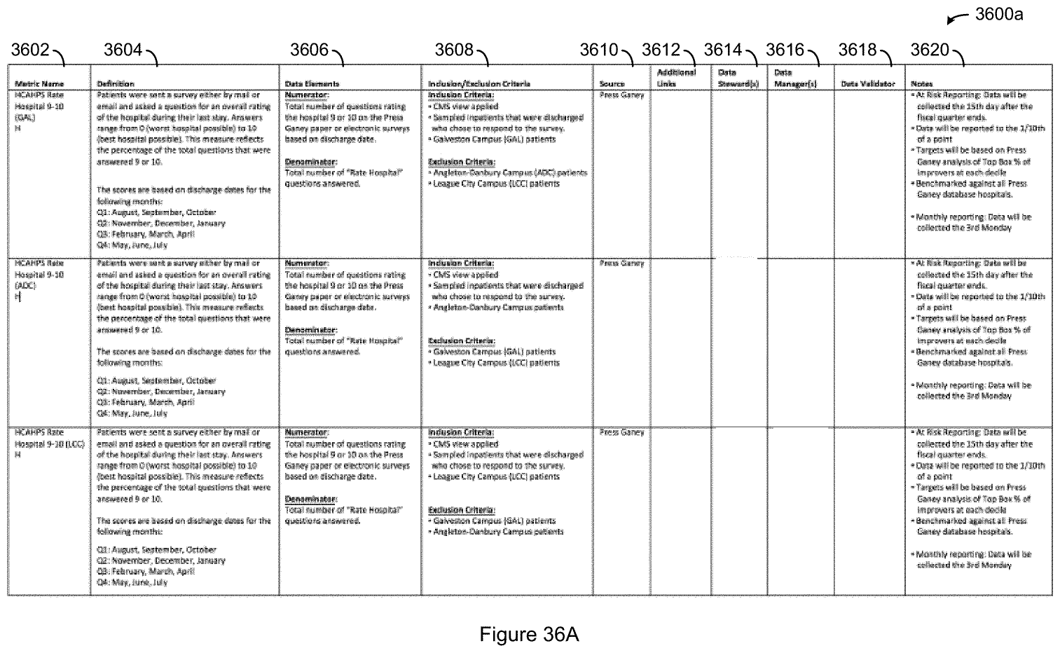

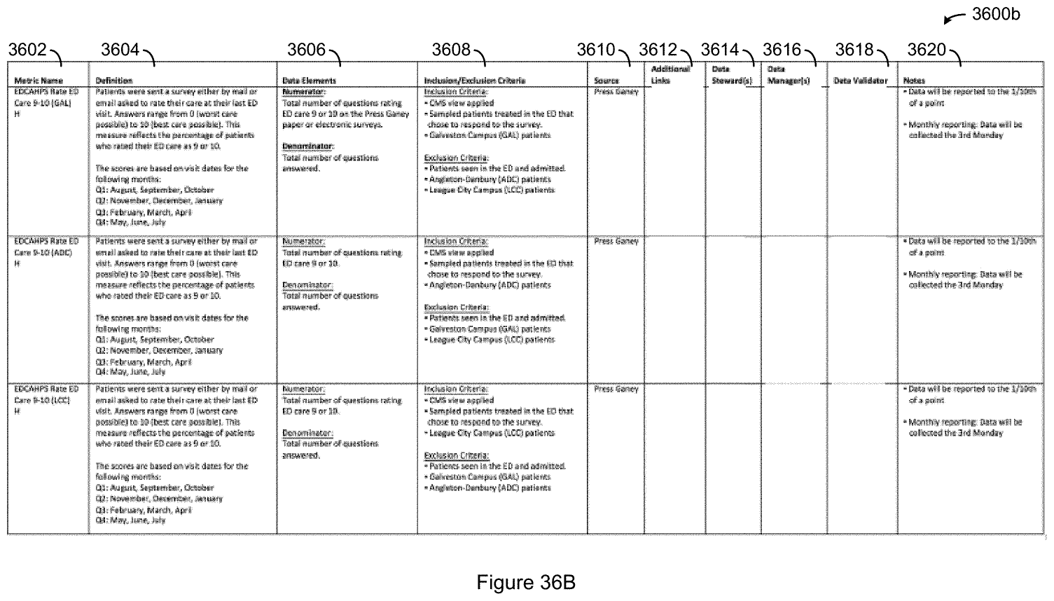

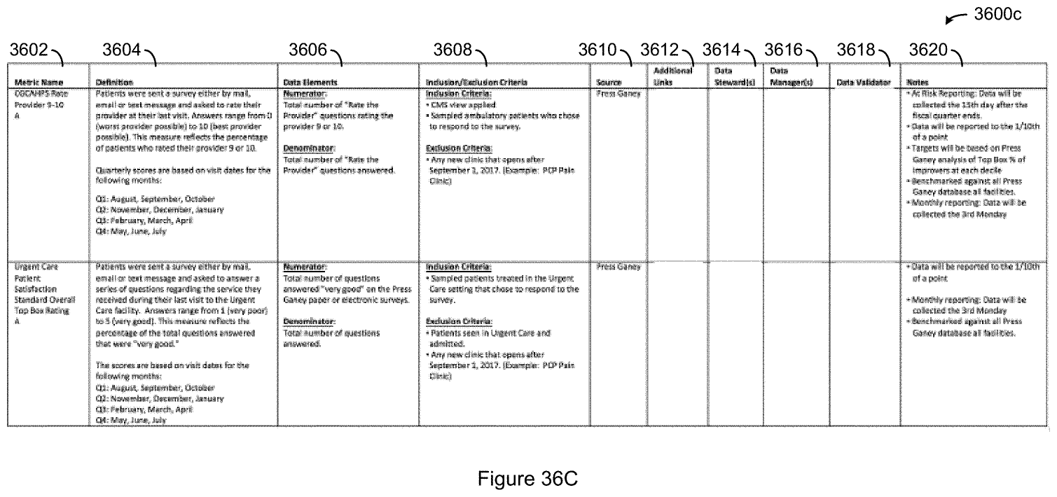

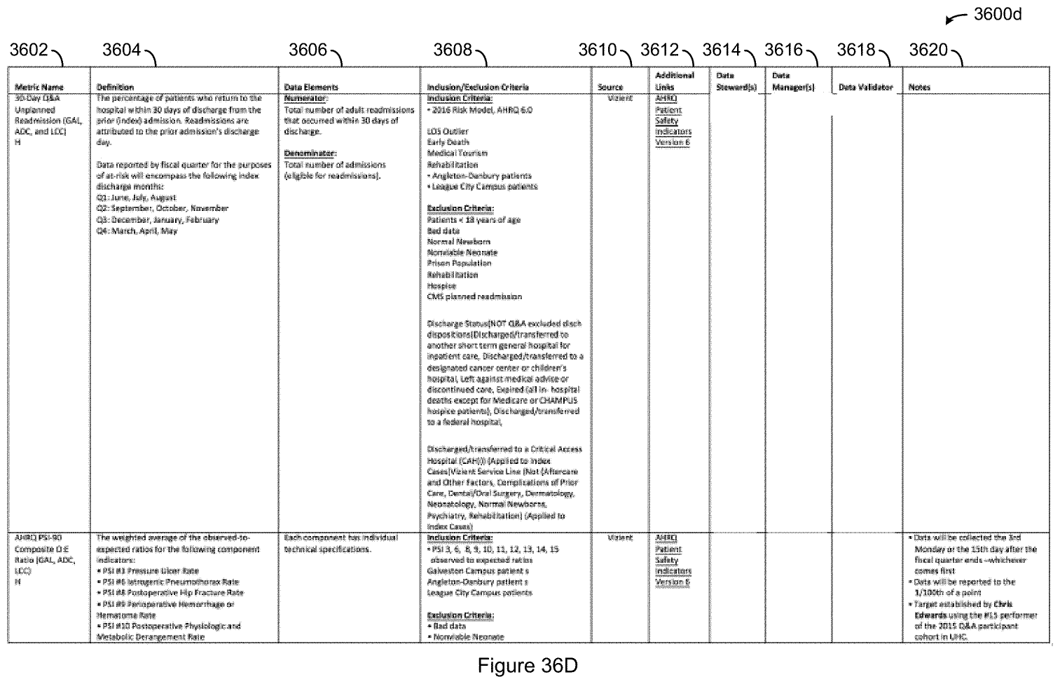

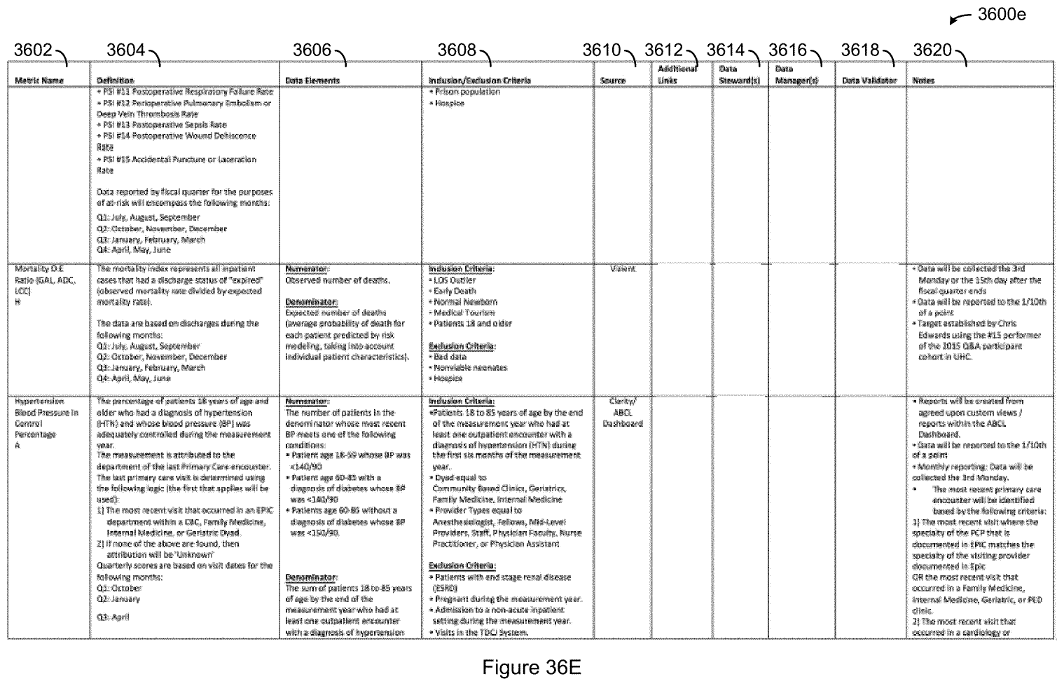

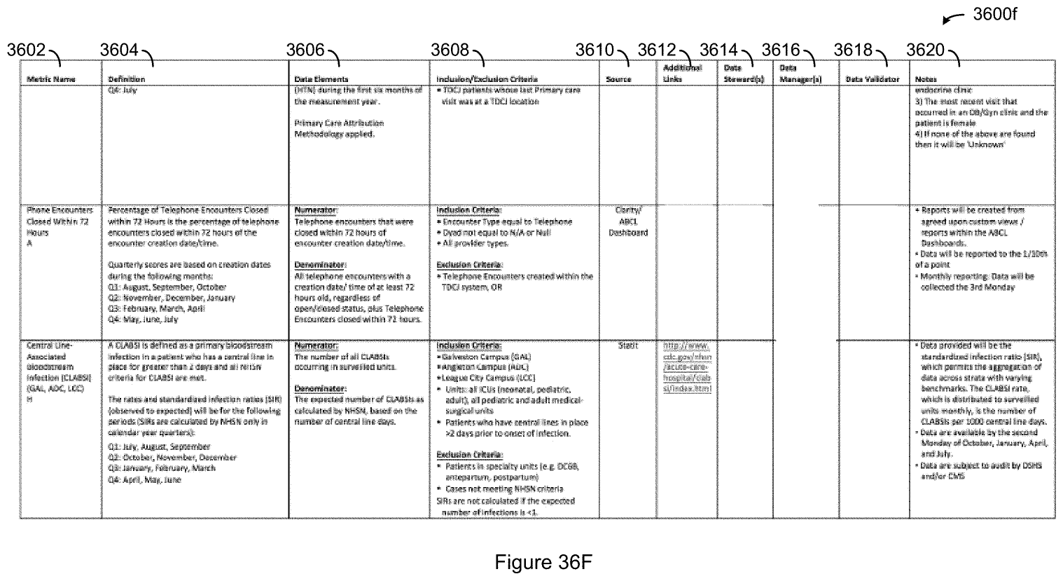

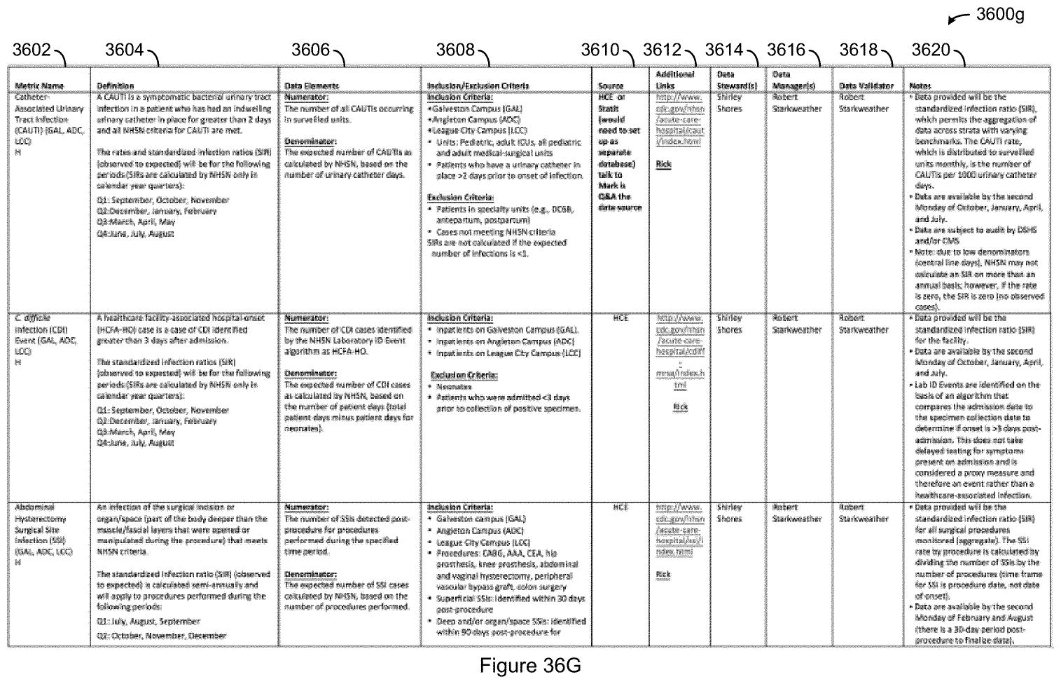

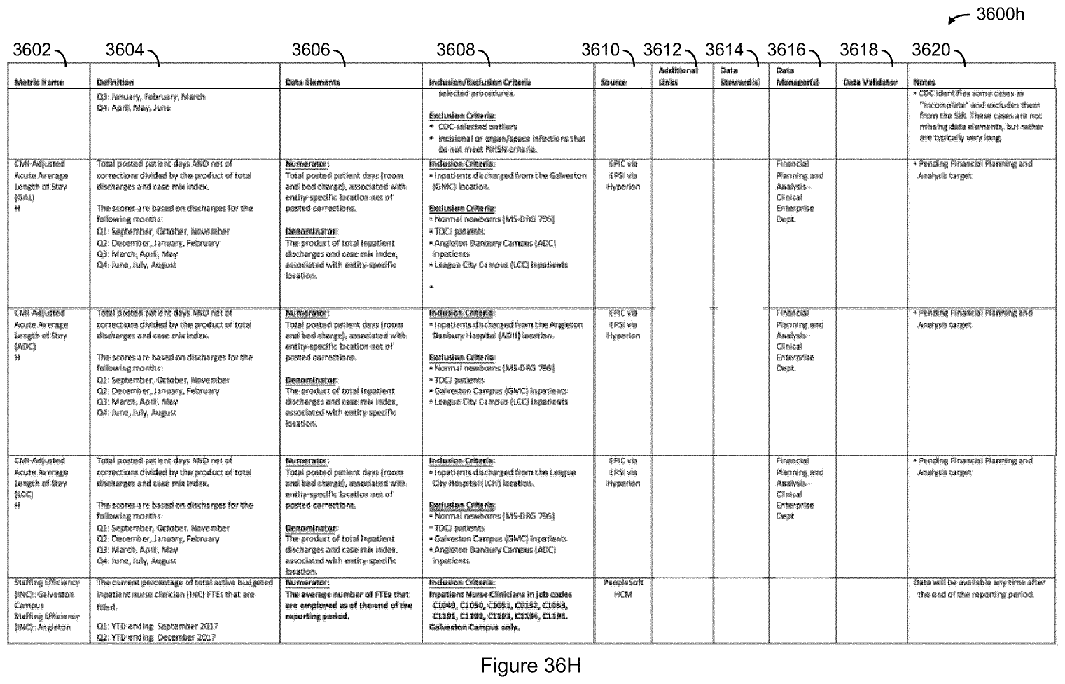

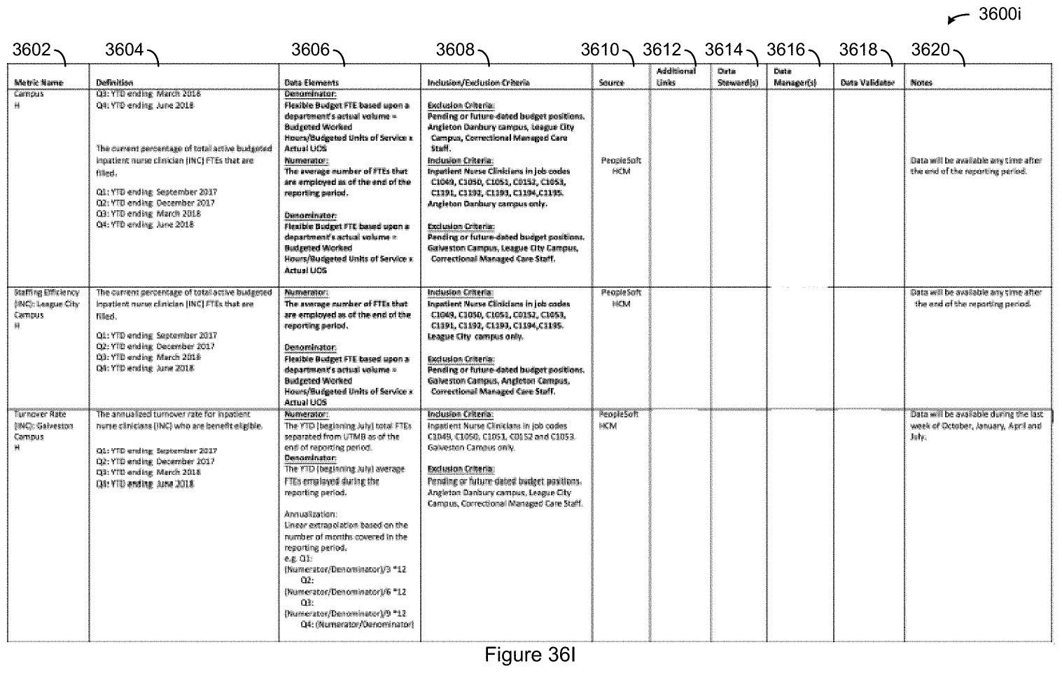

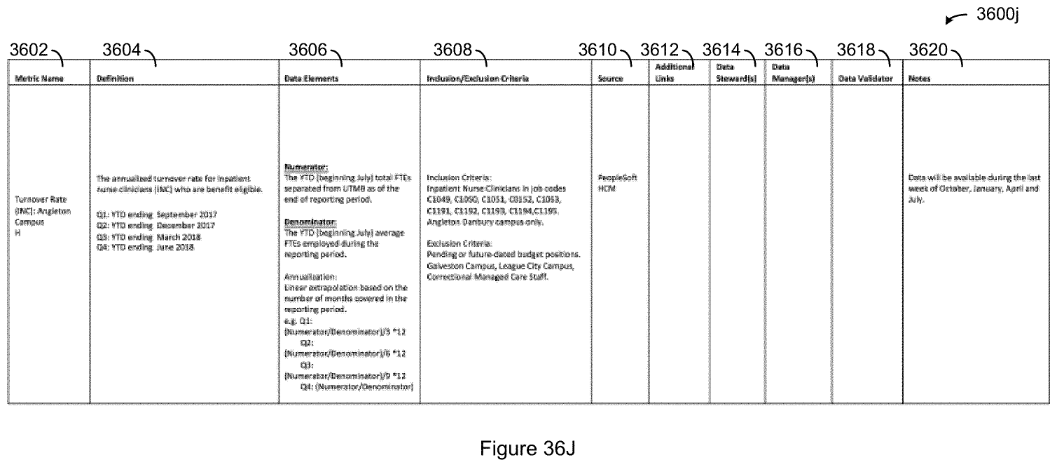

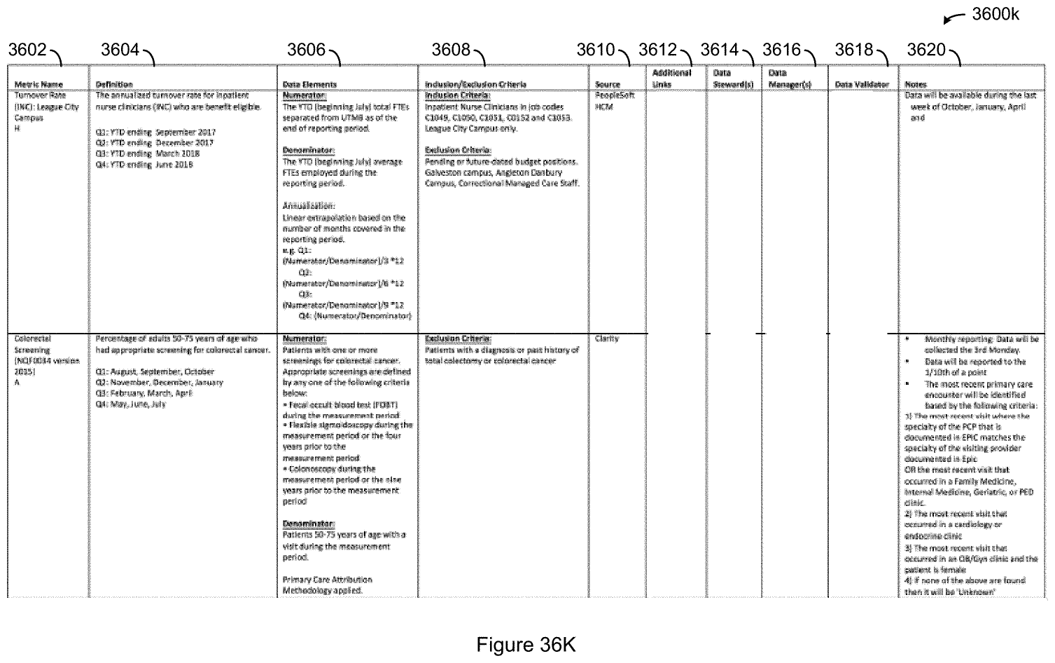

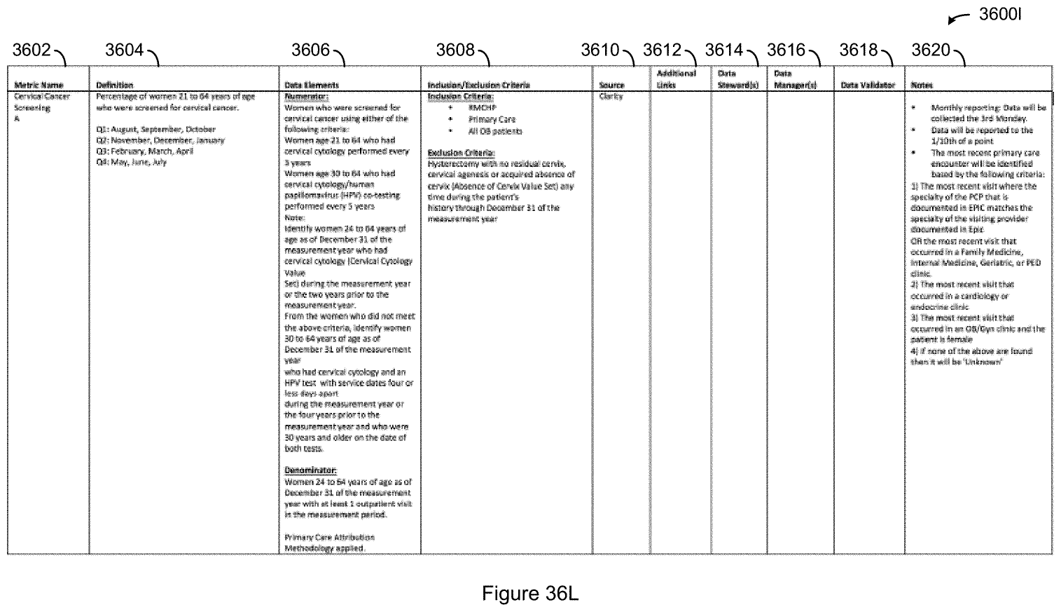

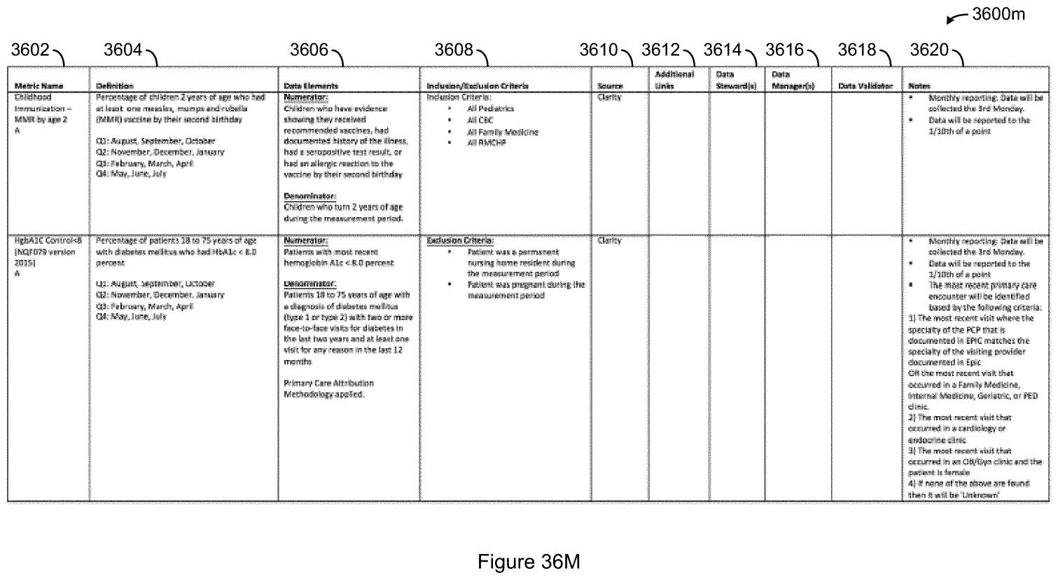

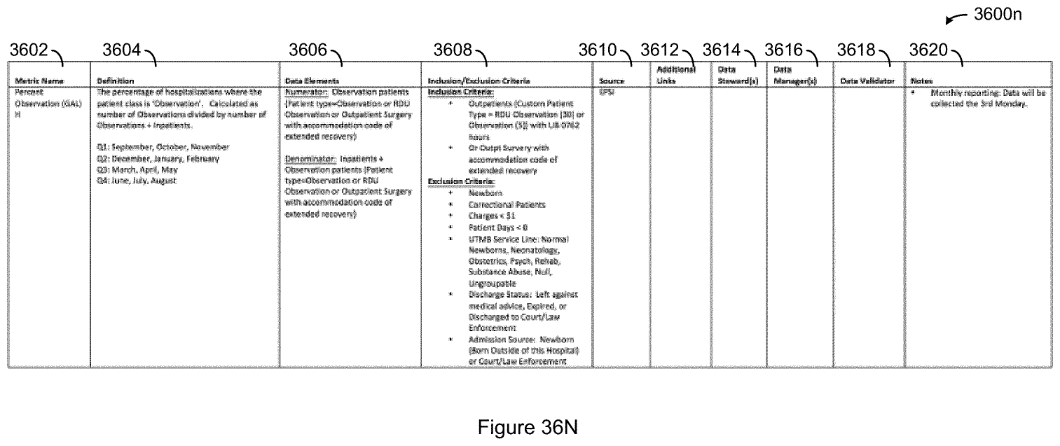

FIGS. 36A-36N provide examples of metrics, goals, and measures used to calculated, assess, and report within and across the modules of the current invention. These metrics, goals, and measures do not represent an exhaustive list but provide examples of some of the measures that can be used. The tables 3600a-3600n provide: metric name 3602, definition 3604, data elements 3606, inclusion/exclusion criteria 3608, database source 3610, additional links 3612, data stewards 3614, data manager 3616, data validator 3618, and notes 3620. The data stewards 3614, data manager 3616 and data validator 3618 columns identify the names of the people having the respective duties. Note that the actual names have been removed from the Figures. In one embodiment, the metrics, goals, and measures include but are not limited to financial, administrative, performance, clinical and quality metrics, goals, and measures.

To facilitate the understanding of this invention, a number of terms are defined below. Terms defined herein have meanings as commonly understood by a person of ordinary skill in the areas relevant to the present invention. Note that these terms may be used interchangeably without limiting the scope of the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

All of the systems, devices, computer programs, compositions and/or methods disclosed and claimed herein can be made and executed without undue experimentation in light of the present disclosure. While the systems, devices, computer programs, compositions and methods of this invention have been described in terms of various embodiments, it will be apparent to those of skill in the art that variations may be applied to the systems, devices, computer programs, compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A computerized method for managing faculty resources comprising:
providing an input/output interface, a memory, and one or more processors communicably coupled to the input/output interface and the memory;
providing a faculty database structure communicably coupled to the one or more processors and one or more databases, wherein the faculty database structure comprises a faculty profile for each faculty member that links personal data, position data, evaluation criteria and performance data together for the faculty member;
selecting one or more of the faculty profiles using the input/output interface;
determining a performance score for each selected faculty profile by comparing the performance data to the evaluation criteria using the one or more processors; and
providing the performance score for each selected faculty profile to the input/output interface.

2. The method of claim 1, wherein:
the faculty member comprises an existing, past or prospective faculty member; or
the evaluation criteria comprises plans, key performance indicators (KPI), benchmarks, or efforts; or
the performance data comprises clinical, administrative, compensation, grant management, teaching or productivity results.

3. The method of claim 1, further comprising updating the faculty profile with the performance score.

4. The method of claim 1, further comprising comparing the performance score of one faculty member to another performance score of one or more other faculty members.

5. The method of claim 1, further comprising determining a management recommendation based on the performance score.

6. The method of claim 5, wherein the management recommendation comprises a hiring, terminating, promoting, disciplining, coaching or retaining recommendation.

7. The method of claim 5, further comprising automatically sending the management recommendation to a device of the selected faculty member.

8. The method of claim 5, further comprising displaying the management recommendation on a visual enabled device comprising at least one of a computer, a smart phone, or tablet.

9. The method of claim 1, further comprising automatically calculating a salary incentive for the faculty member.

10. The method of claim 1, further comprising automatically calculating a teaching effort for the faculty member.

11. The method of claim 1, further comprising automatically calculating a compensation and an associated incentive for a new faculty member.

12. The method of claim 1, further comprising associating two or more faculty profiles with a team.

13. The method of claim 1, further comprising protecting the faculty profiles and the one or more databases using a single security model.

14. The method of claim 1, wherein the personal data comprises at least one unique identifier comprising a faculty name, social security number, employee ID number, or faculty title.

15. The method of claim 1, wherein the faculty further comprises historical or legacy data for aggregate, time-point, or benchmark comparisons with the historical or legacy data of one or more faculty members.

16. The method of claim 1, further comprising displaying at least one of a metric, a recommendation, or a faculty profile comparison in a dashboard format on one or more devices.

17. A system for managing faculty resources comprising:
an input/output interface;
a memory;
one or more processors communicably coupled to the input/output interface and the memory;
a faculty database structure communicably coupled to the one or more processors and one or more databases, wherein the faculty database structure comprises a faculty profile for each faculty member that links personal data, position data, evaluation criteria and performance data together for the faculty member; and
the one or more processors receive one or more of the faculty profiles selected via the input/output interface, determine a performance score for each selected faculty profile by comparing the performance data to the evaluation criteria, and provide the performance score for each selected faculty profile to the input/output interface.

18. The system of claim 17, wherein:
the faculty member comprises an existing, past or prospective faculty member; or
the evaluation criteria comprises plans, key performance indicators (KPI), benchmarks, or efforts; or
the performance data comprises clinical, administrative, compensation, grant management, teaching or productivity results.

19. The system of claim 17, wherein the one or more processors update the faculty profile with the performance score.

20. The system of claim 17, wherein the one or more processors compare the performance score of one faculty member to another performance score of one or more other faculty members.

21. The system of claim 17, wherein the one or more processors determine a management recommendation based on the performance score.

22. The system of claim 21, wherein the management recommendation comprises a hiring, terminating, promoting, disciplining, coaching or retaining recommendation.

23. The system of claim 21, wherein the one or more processors automatically send the management recommendation to a device of the selected faculty member.

24. The system of claim 21, wherein the one or more processors display the management recommendation on a visual enabled device comprising at least one of a computer, a smart phone, or tablet.

25. The system of claim 17, wherein the one or more processors automatically calculate a salary incentive for the faculty member.

26. The system of claim 17, wherein the one or more processors automatically calculate a teaching effort for the faculty member.

27. The system of claim 17, wherein the one or more processors automatically calculate compensation and an associated incentive for a new faculty member.

28. The system of claim 17, wherein the one or more processors associate two or more faculty profiles with a team.

29. The system of claim 17, wherein the faculty profiles and the one or more databases using a single security model.

30. The system of claim 17, wherein the personal data comprises at least one unique identifier comprising a faculty name, social security number, employee ID number, or faculty title.

31. The system of claim 17, wherein the faculty further comprises historical or legacy data for aggregate, time-point, or benchmark comparisons with the historical or legacy data of one or more faculty members.

32. The system of claim 17, wherein the one or more processors display at least one of a metric, a recommendation or a faculty profile comparison in a dashboard format on one or more devices.
